(19) United States
(12) Patent Application Publication
(10) Pub. No.: US 2015/0099186 A1
(43) Pub. Date: Apr. 9, 2015

(54) SILICON NANOCOMPOSITE NANOFIBERS

(71) Applicant: CORNELL UNIVERSITY, ITHACA, NY (US)

(72) Inventors: Yong Lak Joo, Ithaca, NY (US); Nathaniel S. Hansen, Portland, OR (US); Daehwan Cho, Ithaca, NY (US); Kyoung Woo Kim, Austin, TX (US); Yong Seok Kim, Ithaca, NY (US)

(73) Assignee: CORNELL UNIVERSITY, ITHACA, NY (US)

(21) Appl. No.: 14/382,423

(22) PCT Filed: Feb. 28, 2013
(86) PCT No.: PCT/US2013/028165

§ 371 Date: Sep. 2, 2014

Related U.S. Application Data
(60) Provisional application No. 61/605,937, filed on Mar. 2, 2012.
(60) Provisional application No. 61/701,854, filed on Sep. 17, 2012.
(60) Provisional application No. 61/717,222, filed on Oct. 23, 2012.

(51) Int. Cl. H01M 4/133; D01D 5/00; H01M 10/0525; H01M 4/1393; H01M 4/1395; H01M 4/134; D01F 1/09; H01M 4/04

(52) U.S. Cl. CPC H01M 4/133; D01F 1/09; D01D 5/003; H01M 4/0469; H01M 4/0471; H01M 4/1393; H01M 4/1395; H01M 4/134; H01M 10/0525
USPC 429/231.8; 264/484; 252/502

(57) ABSTRACT

Provided herein are silicon nanocomposite nanofibers and processes for preparing the same. In specific examples, provided herein are nanocomposite nanofibers comprising continuous silicon matrices and nanocomposite nanofibers comprising non-aggregated silicon domains.

### CROSS-REFERENCE

This application claims the benefit of U.S. Provisional Application Nos. 61/605,937, filed Mar. 2, 2012, 61/701,854, filed Sep. 17, 2012, and 61/717,222, filed Oct. 23, 2012, all of which are incorporated herein by reference in their entireties.

### BACKGROUND OF THE INVENTION

Batteries comprise one or more electrochemical cell, such cells generally comprising a cathode, an anode and an electrolyte. Lithium ion batteries are high energy density batteries that are fairly commonly used in consumer electronics and electric vehicles. In lithium ion batteries, lithium ions generally move from the negative electrode to the positive electrode during discharge and vice versa when charging. In the as-fabricated and discharged state, lithium ion batteries often comprise a lithium compound (such as a lithium metal oxide) at the cathode (positive electrode) and another material, generally carbon, at the anode (negative electrode).

### SUMMARY OF THE INVENTION

Provided herein is an efficient silicon nanomaterials platform. In some instances, such nanomaterials are suitable for providing improved silicon containing electrodes (e.g., for use in batteries, such as anode in lithium ion batteries). For example, in some instances, provided herein are nanocomposite nanofibers comprising silicon distributed along the length of a nanofiber (e.g., in a non-aggregated manner), which, in some instances, facilitates high silicon loading, and improved lithium ion uptake in the nanofiber/electrode (e.g., with little to no pulverization of the material). Provided herein are silicon nanocomposite nanofibers (including treated and as-spun nanofibers), fluid stocks (e.g., for preparing such nanofibers), and processes for preparing silicon nanocomposite nanofibers (including treated and as-spun nanofibers).

Provided in certain embodiments herein is a or a plurality of nanocomposite nanofibers comprising a continuous matrix of at least one silicon material (e.g., and an additional material, such as carbon, polymer, metal, ceramic, metal oxide, or the like). Also provided in some embodiments herein is a or a plurality of nanocomposite nanofibers comprising a plurality of non-aggregated, discrete domains of at least one silicon material and a second material (e.g., a continuous matrix material, such as carbon, polymer, metal, ceramic, metal oxide, or the like). In specific embodiments, the second material is carbon (e.g., comprising amorphous carbon, or a combination of amorphous and crystalline carbon).

In specific embodiments, provided herein are nanocomposite nanofibers comprising a backbone (e.g., continuous matrix material), the backbone comprising nanoparticles embedded therein, the backbone comprising carbon and the nanoparticles comprising silicon. In some embodiments, the backbone is a core matrix material. In other embodiments, the backbone comprises a hollow core—e.g., along at least a portion of the nanofiber (e.g., with the nanoparticles embedded within the matrix material rather than found within the “hollow” center, such as illustrated in FIG. 2A).

In some embodiments, the backbone or matrix material of a nanofiber described herein comprises amorphous carbon. In certain embodiments, the backbone or matrix material of a nanofiber described herein comprises crystalline carbon (e.g., graphite and/or graphene). In further embodiments, the backbone or matrix material of a nanofiber described herein comprises amorphous carbon and crystalline carbon.

In some embodiments, provided herein is a nanocomposite comprising at least one continuous backbone and at least one discontinuous nanoparticle embedded within the at least one continuous backbone wherein: (a) the at least one continuous backbone comprises one of: a first material comprising silicon; and a second material absent silicon; and (b) the at least one discontinuous nanoparticle comprises the other one of: the first material comprising silicon; and the second material absent silicon. In specific embodiments, the second material absent silicon comprises a second material containing carbon absent silicon.

In certain embodiments, the nanoparticles or discrete domains of a nanofiber provided herein comprise silicon in a zero oxidation state. In further embodiments, the nanoparticles or discrete domains of a nanofiber provided herein comprise silicon in a zero oxidation state (e.g., elemental silicon) and silicon in an oxidized state (e.g., silicon dioxide). In specific embodiments, the nanoparticles comprise elemental silicon and silicon dioxide. In more specific embodiments, the nanoparticles comprise elemental silicon and silicon dioxide in an elemental silicon-to-silicon dioxide ratio of at least 5:1 (e.g., 10:1, 20:1, 30:1, or the like). FIG. 6 illustrates the crystalline nature of certain silicon nanoparticles present in some of the nanofibers described herein.

In certain embodiments, the nanoparticles or discrete domains of a nanofiber provided herein have an average diameter of less than 100 nm. In specific embodiments, the nanoparticles or domains have an average diameter of 10 nm to 80 nm. In more specific embodiments, the nanoparticles or domains have an average diameter of 20 nm to 60 nm.

In some embodiments, a majority of the nanoparticles or discrete domains comprise a surface that is at least 50% coated with carbon. In specific embodiments, a majority of the nanoparticles or discrete domains comprise a surface that is at least 75% coated with carbon. In more specific embodiments, a majority of the nanoparticles or discrete domains comprise a surface that is at least 85% coated with carbon. In still more specific embodiments, a majority of the nanoparticles or discrete domains comprise a surface that is at least 90% coated with carbon. In yet more specific embodiments, a majority of the nanoparticles or discrete domains comprise a surface that is at least 95% coated with carbon. In some specific embodiments, at least 50%, at least 60%, at least 70%, at least 80%, at least 90%, or at least 95% of the nanoparticles or discrete domains comprise a surface that is at least 50%, at least 75%, at least 85%, at least 90%, or at least 95% coated with carbon.

In certain embodiments, the nanoparticles or domains are non-aggregated. For example, FIG. 4 illustrates nanofibers 400 comprising non-aggregated nanoparticles 401 embedded in a matrix or backbone 402 thereof (e.g., as prepared according to a gas assisted electrospinning process described herein). Conversely, FIG. 5 (panels A, B, C, and D) illustrates nanoparticles aggregated in a nanofiber (e.g., as prepared according to a non-gas assisted electrospinning process). In some embodiments, less than 40% of the nanoparticles are aggregated (e.g., as measured in any suitable manner, such as by TEM). In specific embodiments, less than 30% of the nanoparticles are aggregated). In more specific embodiments, less than 25% of the nanoparticles are aggregated). In yet more specific embodiments, less than 20% of the nanoparticles are aggregated). In still more specific embodiments, less than 10% of the nanoparticles are aggregated). In more specific embodiments, less than 5% of the nanoparticles are aggregated).

In some embodiments, the nanoparticles or domains are dispersed along the entire length of the nanofiber.

In some embodiments, nanofibers provided herein comprise, on average, less than 25 wt. % of carbon (e.g., as measured by TGA or elemental analysis). In specific embodiments, the nanofibers comprise, on average, 1 wt % to 25 wt % carbon. In more specific embodiments, the nanofibers comprise, on average, 5 wt % to 25 wt % carbon. In yet more specific embodiments, the nanofibers comprise, on average, 5 wt % to 20 wt % carbon. In still more specific embodiments, the nanofibers comprise, on average, 10 wt % to 20 wt % carbon. In some embodiments, nanofibers provided herein comprise, on average, at least 50 elemental wt. % of silicon (e.g., in silicon and/or silica form). In specific embodiments, nanofibers provided herein comprise, on average, at least 60 elemental wt. % of silicon (e.g., in silicon and/or silica form). In more specific embodiments, nanofibers provided herein comprise, on average, at least 70 elemental wt. % of silicon (e.g., in silicon and/or silica form). In still more specific embodiments, nanofibers provided herein comprise, on average, at least 75 elemental wt. % of silicon (e.g., in silicon and/or silica form). In yet more specific embodiments, nanofibers provided herein comprise, on average, at least 80 elemental wt. % of silicon (e.g., in silicon and/or silica form). In specific embodiments, nanofibers provided herein comprise, on average, at least 85 elemental wt. % of silicon (e.g., in silicon and/or silica form). In some embodiments, nanofibers provided herein comprise, on average, at least 50 wt. % of silicon (i.e., zero oxidation/elemental silicon). In specific embodiments, nanofibers provided herein comprise, on average, at least 60 wt. % of silicon (i.e., zero oxidation/elemental silicon). In yet more specific embodiments, nanofibers provided herein comprise, on average, at least 70 wt. % of silicon (i.e., zero oxidation/elemental silicon). In still more specific embodiments, nanofibers provided herein comprise, on average, at least 75 wt. % of silicon (i.e., zero oxidation/elemental silicon). In more specific embodiments, nanofibers provided herein comprise, on average, at least 80 wt. % of silicon (i.e., zero oxidation/elemental silicon). In still more specific embodiments, nanofibers provided herein comprise, on average, at least 85 wt. % of silicon (i.e., zero oxidation/elemental silicon).

In some embodiments, nanofibers provided herein have X-Ray diffraction (XRD) two theta peaks at three or more of the following: 28.37°±0.03, 47.20°±0.03, 56.09°±0.03, 69.02°±0.03, and 76.37°±0.03. In specific embodiments, the XRD peaks of nanofibers provided herein have at least four of such peaks. In more specific embodiments, the XRD peaks of nanofibers provided herein have all five of such peaks. In other embodiments, the XRD peaks of nanofibers provided herein have at least two of such peaks. In some embodiments, a nanofiber provided herein has an XRD pattern of FIG. 6 (e.g., similar or identical thereto—such as the variations of FIG. 12).

In certain embodiments, nanofibers provided herein (or anodes comprising such nanofibers) have a specific energy capacity of at least 1500 mAh/g on a first cycle at 0.1 C. In specific embodiments, nanofibers provided herein (or anodes comprising such nanofibers) have a specific energy capacity of at least 2000 mAh/g on a first cycle at 0.1 C. In some embodiments, nanofibers provided herein (or anodes comprising such nanofibers) have a specific energy capacity of at least 250 mAh/g on a 98th cycle at 0.1 C. In specific embodiments, nanofibers provided herein (or anodes comprising such nanofibers) have a specific energy capacity of at least 400 mAh/g on a 98th cycle at 0.1 C.

Reference to silicon herein includes specific disclosure of elemental silicon, whereas silicon material includes silicon, oxidized silicon, silicon alloys, and the like. Reference to silicon nanoparticles herein includes specific disclosure to nanoparticles comprising elemental silicon (with other optional agents, including other silicon materials, present).

In certain embodiments, provided herein is a or a plurality of nanocomposite nanofibers comprising both a continuous matrix of at least one silicon material and a plurality of non-aggregated, discrete domains of at least one silicon material (e.g., in the silicon material continuous matrix or a second continuous matrix).

In some embodiments, the non-aggregated discrete domains comprise non-aggregated nanoparticles comprising at least one silicon material. In certain embodiments, the nanofibers do not comprise a concentration of domains 20 times higher along a 500 nm long segment along the length of the nanofiber than an adjacent 500 nm length of the nanofiber. In some embodiments, the discrete domains comprise at least 50% (e.g., at least 90%) by weight silicon having an oxidation state of zero. In specific embodiments, the discrete domains comprise at least 95% by weight silicon having an oxidation state of zero (elemental silicon).

In certain embodiments, the nanocomposite nanofibers are coaxially layered nanofibers, the nanofibers comprising a core and a sheath that at least partially surrounds the core. In specific embodiments, the core comprises silicon material. In further or alternative embodiments, the sheath comprises silicon material.

In certain embodiments, nanofibers provided herein comprise (e.g., on average) at least 20% by weight of the silicon containing material. In specific embodiments, nanofibers provided herein comprise (e.g., on average) at least 30% by weight of the silicon containing material. In more specific embodiments, nanofibers provided herein comprise (e.g., on average) at least 50% by weight of the silicon containing material. In still more specific embodiments, nanofibers provided herein comprise (e.g., on average) at least 70% by weight of the silicon containing material. In some embodiments, nanofibers provided herein comprise no more than 90% by weight (e.g., on average) of the silicon containing material. In specific embodiments, the silicon material is elemental silicon. In other specific embodiments, the silicon material comprises both elemental silicon (i.e., zero oxidation state silicon) and a silicon oxide (e.g., silicon dioxide). In other specific embodiments, the silicon material comprises elemental silicon (i.e., zero oxidation state silicon), a silicon oxide, and silicon carbide. FIG. 17 illustrates an X-Ray photoelectron spectrograph (XPS) of silicon/carbon nanocomposite nanofibers described herein. In certain embodiments, nanofibers provided herein comprise (e.g., on average) at least 10% by weight of the second material. In specific embodiments, nanofibers provided herein comprise (e.g., on average) at least 20% by weight of the second material. In more specific embodiments, nanofibers provided herein comprise (e.g., on average) at least 30% by weight of the second material. In some embodiments, nanofibers provided herein comprise (e.g., on average) less than 30% by weight of the second material. In specific embodiments, nanofibers provided herein comprise (e.g., on average) less than 20% by weight of the second material.

In specific embodiments, nanofibers provided herein comprise (e.g., on average) at least 60% by weight of a silicon containing material (e.g., comprising silicon and silicon oxide) and less than 30% by weight of a second material (e.g., carbon).

In certain embodiments, the nanofibers provided herein comprise (e.g., on average) at least 30% by weight (on an elemental basis) of silicon. In specific embodiments, the nanofibers provided herein comprise (e.g., on average) at least 50% by weight (on an elemental basis) of silicon. In specific embodiments, the nanofibers provided herein comprise (e.g., on average) at least 70% by weight (on an elemental basis) of silicon.

In some embodiments, the second material comprises ceramic, metal, organic polymer, or carbon. In specific embodiments, the second material comprises carbon. In other specific embodiments, the second material comprises an organic polymer, e.g., water-soluble organic polymer. In other specific embodiments, the second material comprises carbon (e.g., following carbonization from a water-soluble organic polymer).

In certain embodiments, the nanofiber(s) has an average diameter of less than 1 micron (e.g., less than 800 nm). In some embodiments, the nanofiber(s) has an average aspect ratio of at least 100 (e.g., at least 1000 or at least 10,000). In some embodiments, the nanofibers are cross-linked.

Also provided herein is an electrode comprising a non-woven mat of a plurality of nanocomposite nanofibers described herein. Further, provided herein is a battery (e.g., lithium ion battery) comprising such an electrode. In more specific embodiments, the lithium ion battery comprises, such as in an initial or discharged state, a positive electrode, a separator, and a negative electrode, the negative electrode comprising any nanocomposite nanofiber as described herein, or a woven mat comprising one or a plurality of such nanocomposite nanofibers.

Provided in certain embodiments herein is a process of producing a nanocomposite nanofiber (e.g., as described above), the process comprising electrospinning a fluid stock, the fluid stock comprising or prepared by combining, in any order, a silicon component, an organic polymer, and a fluid. In specific embodiments, the fluid comprises water or is aqueous. In some embodiments, the organic polymer is a water-soluble polymer. In certain embodiments, the weight-to-weight ratio of the silicon component (e.g., silicon precursor) to organic polymer is at least 1:2 (e.g., at least 1:1). In some embodiments, the weight-to-weight ratio of the silicon component (e.g., silicon nanoparticles) to organic polymer is at least 1:10 (e.g., at least 1:5, at least 1:4, at least 1:3, at least 1:2, at least 1:1, 1:10 to 1:1, or 1:5 to 1:1). In some embodiments, the process further comprises thermally treating the as-spun nanofiber. In some embodiments, the thermal treatment occurs under inert conditions (e.g., to carbonize the polymer). In further or alternative embodiments, the process comprises oxidizing the as-spun nanofiber (e.g., concurrently with thermal treatment) (e.g., to remove the polymer). In further or alternative embodiments, the process further comprises reducing the as-spun (or a previously treated, e.g., thermally treated) nanofiber (e.g., concurrently with thermal treatment) (e.g., to minimize oxidation of metal components).

In some embodiments, the process comprises electrospinning the fluid stock with gas assistance. In specific embodiments, the process comprises electrospinning the fluid stock with coaxial gas assistance. In some embodiments, the gas assistances is provided by blowing gas (e.g., high velocity gas) along or around (i.e., coaxially) a common axis as the fluid stock is electrospun. In some embodiments, the fluid stock is electrospun with a high velocity gas flowing adjacent to and about or along the same axis as the electrospun fluid stock (e.g., within 1, 5 or 10 degrees of the axis along which the fluid stock is electrospun). FIG. 1 and FIG. 3 illustrate exemplary systems for providing coaxial gas assisted electrospinning of a fluid stock.

In some embodiments, the silicon component is a silicon containing nanoparticle (e.g., comprising zero oxidation state silicon). In other embodiments, the silicon component is a silicon precursor (e.g., silicon acetate). In specific embodiments, the silicon precursor comprises silicon carboxylate (e.g., silicon acetate), silicon halide (e.g., silicon chloride), silicon alkoxide, or a combination thereof. In certain embodiments, the polymer is nucleophilic. In some embodiments, the polymer is polyvinyl alcohol (PVA), polyvinyl acetate (PVAc), polyethylene oxide (PEO), polyvinyl ether, polyvinyl pyrrolidone, polyglycolic acid, hydroxyethylcellulose (HEC), ethylcellulose, cellulose ethers, polyacrylic acid, polyisocyanate, or a combination thereof.

In some embodiments, the process further comprises, to prepare the fluid stock, comprises combining, in any order, the silicon component, the polymer and a fluid medium (e.g., water or an aqueous solution). In further embodiments, the fluid stock comprises at least one non-silicon metal precursor (e.g., prepared by combining a non-silicon metal precursor with the other components, in any suitable order). In specific embodiments, non-silicon metal precursors include, by way of non-limiting example, molybdenum precursor, niobium precursor, tantalum precursor, tungsten precursor, iron precursor, nickel precursor, copper precursor, cobalt precursor, manganese precursor, titanium precursor, vanadium precursor, chromium precursor, zirconium precursor, yttrium precursor, or a combination thereof. In some embodiments, the metal concentration (including silicon and non-silicon metal) in the fluid stock is at least 200 mM (e.g., at least 250 mM, or at least 300 mM), wherein the molarity is based on moles of metal atoms, irrespective of what form the metal (including silicon) may take.

Disclosure of characteristics of a single nanofiber described herein includes the disclosure of a plurality of nanofibers having the average characteristic described. Similarly, disclosure of an average characteristic of a plurality of nanofibers includes the disclosure of a single nanofiber having the characteristic described.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a multi-axial electrospinning (multiple fluids about a substantially common axis) system for preparing a coaxially layered nanocomposite nanofiber, and a coaxially layered nanocomposite nanofiber. Also, FIG. 1 describes a system for preparing a nanocomposite nanofiber with domains embedded in a continuous matrix wherein electrospinning of such a nanofiber, or precursor of such a nanofiber, is coaxially gas assisted—e.g., wherein at least one of the layers of a needle apparatus 111 is absent.

FIG. 2A illustrates a nanocomposite nanofiber comprising (i) a hollow core, (ii) discrete domains of a first material in the sheath layer, and (iii) a continuous matrix (e.g., core matrix) of a second material in the sheath layer. FIG. 2B illustrates a nanocomposite nanofiber comprising (i) discrete domains of a first material, and (ii) a continuous matrix (e.g., core matrix) of a second material.

FIG. 3 illustrates a bi-layered co-axial electrospinning apparatus (with a cut-out of the outer needle), having an inner needle and an outer needle coaxially aligned about a common axis. In some instances, the inner and outer needles are configured to coaxially electrospin a first (core) layer and second (e.g., shell or coat) layer. In other instances, the inner and outer needles are configured to electrospin a first fluid stock along with a gas (e.g., in a gas assisted manner when the gas is in the outer layer or to provide hollow nanofibers when the gas is in the inner/core layer).

FIG. 4 illustrates various silicon containing nanocomposite nanofibers described herein. Panel A illustrates an SEM image of a silicon/polymer nanocomposite nanofiber prepared according to a process described herein. Panel B illustrates an SEM image of and panel C illustrates a TEM image of a silicon/carbon nanocomposite nanofibers prepared according to a process described herein.

FIG. 5 illustrates certain nanofibers prepared by electrospinning a fluid stock comprising polymer and nanoparticles without a gas-assisted process described herein. Panels A and B illustrate PVA/Si nanofibers and panels C and D illustrate PAN/Si nanofibers.

FIG. 6 illustrates an X-Ray diffraction (XRD) pattern of a Si/C nanocomposite nanofiber described herein.

FIG. 7 illustrates charge/discharge curves of 1^{st} cycle and 25^{th} cycle (panel A) and plotted curves of Coulombic efficiencies (panel B) for Si/C nanocomposite nanofibers provided herein compared against Si nanoparticles alone.

FIG. 8 illustrates plotted graphs of discharge capacities of certain Si/C nanocomposite nanofibers provided herein compared to silicon nanoparticles alone.

FIG. 9 illustrates a TEM image for silicon/carbon nanocomposite nanofibers prepared by process described herein (wherein the nanoparticles have an average diameter of about 50 nm).

FIG. 10 illustrates cyclic voltammograms (panel A) and Nyquist plots (panel B) of silicon nanoparticles and certain Si/C nanocomposite nanofibers described herein.

FIG. 11 (Panel A) illustrates an SEM of an as-spun polymer-Si (nanoparticle) nanocomposite nanofiber, (Panel B) an SEM image of a silicon/carbon nanocomposite nanofiber prepared by thermal treatment of the nanofibers of Panel A at 900° C.; and (panel C) an SEM image of a silicon/carbon nanocomposite nanofiber prepared thermal treatment of the nanofibers of Panel A at 1200° C.

FIG. 12 illustrates normalized XRD peaks for certain Si/C nanocomposite nanofibers prepared by thermal treatment of certain Si/polymer nanocomposite nanofibers at 500, 700, and 900° C.

FIG. 13 illustrates SEM images for certain Si/C nanocomposite nanofibers prepared by thermal treatment of certain Si/polymer nanocomposite nanofibers at 500° C. (panel A), 700° C. (panel B), and 900° C. (panel C).

FIG. 14 illustrates various polymer-Si (nanoparticle) nanocomposite nanofibers (panels A-C) and the thermally treated products thereof (panels D-F).

FIG. 15 illustrates TGA curves for Super P (Timcal) carbon (a) compared to silicon/carbon nanocomposite nanofibers prepared by treatment at 900° C. (b) and 1200° C. (c).

FIG. 16 illustrates Raman spectra for Super P (Timcal) carbon (a) compared to silicon/carbon nanocomposite nanofibers prepared by treatment at 900° C. (b) and 1200° C. (c).

FIG. 17 illustrates an X-Ray photoelectron spectrograph (XPS) of silicon/carbon nanocomposite nanofibers described herein. Trace (a) corresponds to silicon-silicon; trace (b) corresponds to silicon-carbide; and trace (c) corresponds to silicon-oxide.

FIG. 18 (Panel A) illustrates an SEM of a hollow as-spun 5:1 polymer-Si (100 nm average nanoparticle) nanocomposite nanofiber, (Panel B) an SEM image of a silicon/carbon nanocomposite nanofiber prepared by thermal treatment.

FIG. 19 (Panel A) illustrates an SEM of a hollow as-spun 3.2:1 polymer-Si (100 nm average nanoparticle) nanocomposite nanofiber, (Panel B) an SEM image of a silicon/carbon nanocomposite nanofiber prepared by thermal treatment.

FIG. 20 (Panel A) illustrates an SEM of a hollow as-spun 1.84:1 polymer-Si (100 nm average nanoparticle) nanocomposite nanofiber, (Panel B) an SEM image of a silicon/carbon nanocomposite nanofiber prepared by thermal treatment.

FIG. 21 illustrates a TEM image of (panel A) hollow Si/C nanocomposite nanofibers and (panel B) microtomed hollow Si/C nanocomposite nanofibers described herein (from Si nanoparticles having an average diameter of 100 nm).

FIG. 22 (Panel A) illustrates an SEM of a hollow as-spun polymer-Si (50 nm average nanoparticle) nanocomposite nanofiber, (Panel B) an SEM image of a silicon/carbon nanocomposite nanofiber prepared by thermal treatment.

FIG. 23 illustrates TEM images of (panel A) hollow Si/C nanocomposite nanofibers and (panel B) microtomed hollow Si/C nanocomposite nanofibers described herein (from Si nanoparticles having an average diameter of 50 nm).

### DETAILED DESCRIPTION OF THE INVENTION

Provided herein are silicon containing nanocomposite nanofibers and nanofiber mats and processes for preparing silicon containing nanocomposite nanofibers and nanofiber mats. In some embodiments, a nanofiber (e.g., of a plurality of nanofibers, of a nanofiber mat, or of a process described herein) comprise a first material and a second material, the first material comprising a silicon containing material. In further embodiments, the first material, the second material, or both form a continuous matrix within the nanofiber. In specific embodiments, both the first and second materials form continuous matrix materials within the nanofiber. In other specific embodiments, the first material comprises a plurality of discrete domains within the nanofiber. In more specific embodiments, the second material is a continuous matrix material within the nanofiber.

In some embodiments, nanofibers provide herein are coaxially layered nanofibers, the nanofibers comprising a core and a sheath that at least partially surrounds the core. In some embodiments, the sheath runs along the entire length of the nanofiber. In other embodiments, the sheath runs along at least a portion of the nanofiber. In certain embodiments, the core comprises a silicon material and the sheath comprises a second material. In other embodiments, the sheath comprises a silicon material and the core comprises a second material. In specific embodiments, the second material is a second silicon material (i.e., both the sheath and the core comprise a silicon material, which may be the same or different). In other embodiments, the second material is a non-silicon containing material.

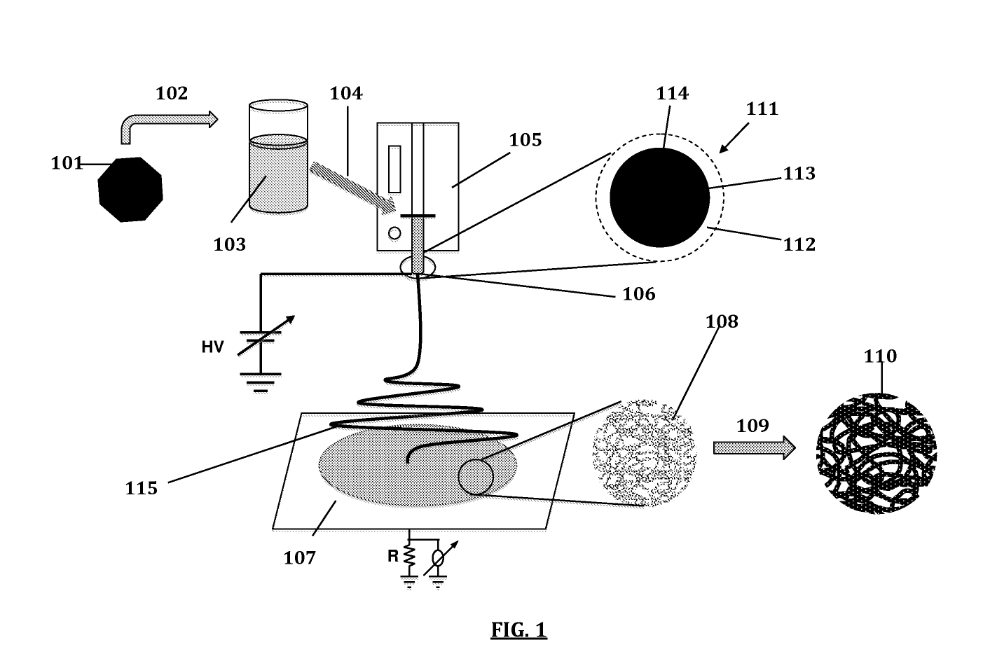

FIG. 1 illustrates a nanofiber 108 provided herein comprising a nanocomposite nanofiber. In some instances, the nanocomposite nanofiber comprises a first and a second continuous matrix material, wherein the first and second continuous matrix materials are coaxially layered. In specific embodiments, the first (silicon containing) material forms the core 114 of the coaxially layered nanofiber 108 (illustrated in the cross sectional view 111—which also illustrates an optional needle apparatus configuration) and the second material forms a layer 113 at least partially surrounding the core 114 (e.g., wherein an outer layer 112 is absent). In other specific embodiments, the second material forms the core 114 of the coaxially layered nanofiber 115 (illustrated in the cross sectional view 111) and the first (silicon containing) material forms a layer 113 at least partially surrounding the core 114. In some instances, the nanofibers are prepared by coaxially electrospinning the two layers with a third coaxial layer 112. In some embodiments, the third coaxial layer 112 comprises a third matrix material. In other embodiments, the third coaxial layer 112 comprises air, e.g., for gas assisting the electrospinning process. Moreover, in some embodiments, the core 114 is optionally hollow, with one or both of the outer layers 112 and/or 113 comprising a silicon material.

FIG. 1 also illustrates an exemplary system or schematic of a process described herein, particularly a system or process for preparing a coaxially layered nanocomposite nanofiber (e.g., by a coaxial gas assisted electrospinning process). In some instances, a first fluid stock 104 (e.g., comprising a silicon component and a polymer) is prepared by combining 102 a silicon component (e.g., silicon precursor or nanoparticle) 101. In some embodiments, the fluid stock is provided 104 to an electrospinning apparatus 105 having a needle apparatus 106. In some embodiments, the fluid stock 103 is electrospun with a second fluid stock (not shown). In some instances, the fluid stock and second fluid stock are optionally electrospun through a needle apparatus 106, with an optional cross section illustrated by 111. In some instances, the fluid stock is electrospun through any one of layers 112, 113, or 114. In certain instances, the second fluid stock, if present, is electrospun through any other of layers 112, 113, or 114. In some instances, for a two-layered nanocomospite nanofiber, the fluid stock and the second fluid stock are electrospun through needles 114 and 113, while a gas is provided through needle 112—e.g., providing an gas assisted electrospinning process or system. In some embodiments, the first fluid, a second fluid stock (e.g., comprising a second metal precursor and a second polymer, the second precursor and polymer independently being either the same or different from the first), and a third fluid (e.g., gas or third fluid stock) are each electrospun through one of needles 112, 113, and 114. The fluid stocks may be provided to an electrospinning apparatus (e.g., an electrospinning needle apparatus with voltage supplied thereto—e.g., voltage sufficient to overcome the surface tension of a liquid polymer or polymer solution to produce a jet) by any device, e.g., by a syringe 105 or a pump. A gas may be provided to an electrospinning needle apparatus 106, 111 from any source (e.g., air pump). 111 is representative of an exemplary cross section of a coaxial needle apparatus or a coaxially layered nanofiber. For example, exemplary co-axial needles comprise an outer sheath tube (which would be represented by 112) at least one intermediate tube (which is optionally absent, which would be represented by 113), and a core tube (which would be represented by 114). In specific embodiments, such tubes are aligned along a common axis (e.g., aligned within 5 degrees of one another). In some instances, the tubes are slightly offset, but the angle of the tubes is substantially aligned (e.g., within 5 degrees of one another). The electrospun jet 115 is collected on a collector 107 as an as-spun (hybrid or nanocomposite) nanofiber 108, which is optionally thermally treated 109 to produce calcined nanofibers 110. In some instances, wherein a dual layered needle apparatus 111 is utilized for electrospinning a fluid stock comprising polymer and silicon nanoparticles (e.g., wherein the fluid stock is provided through needle 114, wherein needle 113 is absent, and a gas is provided through needle 112), a silicon nanoparticle in polymer nanocomposite nanofiber is produced, and upon thermal treatment (e.g., in inert conditions) produces a silicon nanoparticle (e.g., non-aggregated) in carbon nanocomposite nanofiber.

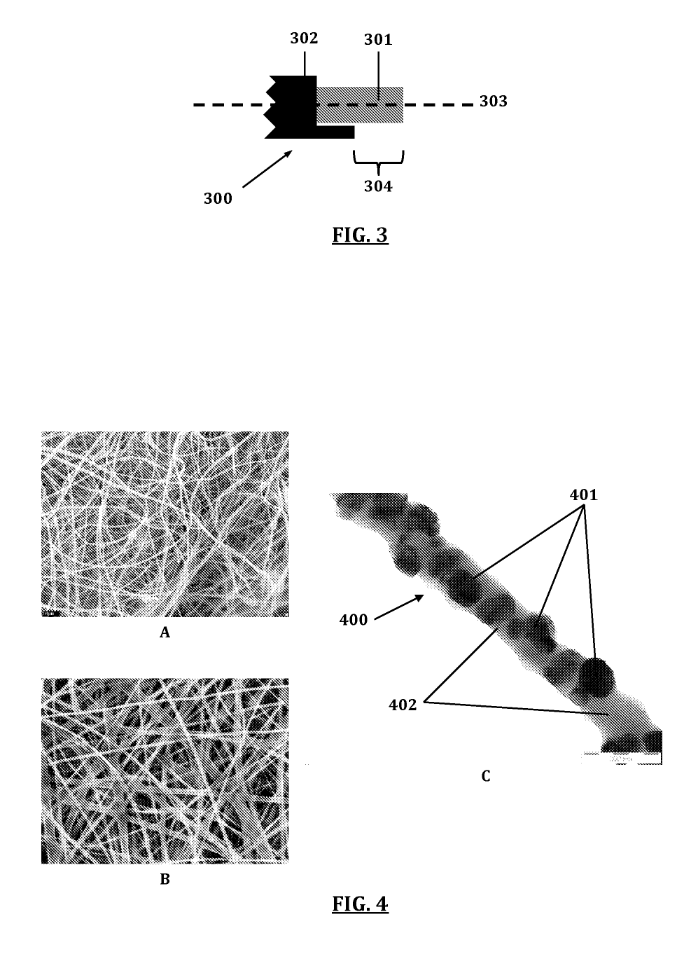

In some embodiments, gas assisted electrospinning processes or apparatus described herein providing a device configured to provide a flow of gas along the same axis as an electrospun fluid stock. In some instances, that gas (or gas needle) is provided along the same axis with the fluid stock (or fluid stock needle) (e.g., and adjacent thereto). In specific instances, the gas (or gas needle) is provided coaxially with the fluid stock (or fluid stock needle). FIG. 3 illustrates co-axial electrospinning apparatus 300. The coaxial needle apparatus comprises an inner needle 301 and an outer needle 302, both of which needles are coaxially aligned around a similar axis 303 (e.g., aligned with 5 degrees, 3 degrees, 1 degree, or the like). In some embodiments, further coaxial needles may be optionally placed around, inside, or between the needles 301 and 302, which are aligned around the axis 303 (e.g., as illustrated in FIG. 1). In some instances, the termination of the needles is optionally offset 304.

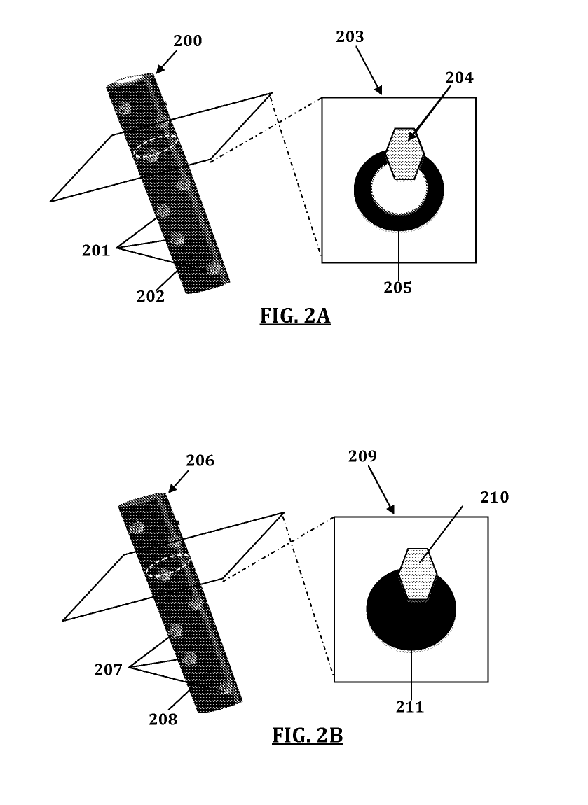

In some embodiments, a nanocomposite nanofiber provided herein comprises (i) a silicon material (e.g., silicon); and (ii) a continuous matrix material (e.g., ceramic, metal, or carbon). In certain embodiments, the continuous matrix is a continuous core matrix (e.g., not a hollow tube). In some embodiments, the silicon material forms discrete isolated domains of the nanocomposite nanofibers. In some specific embodiments, the silicon material domains are non-aggregated. In some embodiments, the silicon material is a nanoparticle comprising silicon. In certain embodiments, the silicon discrete domain material (e.g., silicon nanoparticle) is embedded within the continuous matrix material (e.g., in a continuous matrix material/backbone material), such as illustrated in FIG. 2 or FIG. 4 or FIG. 9.

FIG. 2A illustrates a silicon nanocomposite nanofiber 200 comprising (i) a hollow core, (ii) discrete domains of silicon material 201 in the sheath layer, and (ii) a continuous core matrix 202 in the sheath layer. As illustrated in the cross-sectional view 203, the discrete domains of silicon material 204 may penetrate into the core 205 of the nanocomposite nanofiber. FIG. 2B illustrates a silicon nanocomposite nanofiber 206 comprising (i) discrete domains of silicon material 207 in/on a (ii) a continuous core matrix 208 layer. As illustrated in the cross-sectional view 209, the discrete domains of silicon material 210 may penetrate into the core 211 of the nanocomposite nanofiber. In some instances, the nanocomposite nanofibers comprise silicon material on the surface of the nanofiber. And in some instances, the nanofibers comprise or further comprise discrete domains of silicon material completely embedded within the core matrix material.

In certain embodiments, continuous matrix materials of any nanocomposite nanofiber described herein is continuous over at least a portion of the length of the nanocomposite nanofiber. In some embodiments, the continuous matrix material runs along at least 10% the length of the nanofiber (e.g., on average for a plurality of nanofibers). In more specific embodiments, the continuous matrix material runs along at least 25% the length of the nanofiber (e.g., on average for a plurality of nanofibers). In still more specific embodiments, the continuous matrix runs along at least 50% the length of the nanofiber (e.g., on average for a plurality of nanofibers). In yet more specific embodiments, the continuous matrix runs along at least 75% the length of the nanofiber (e.g., on average for a plurality of nanofibers). In some embodiments, the continuous matrix is found along at least 50%, at least 60%, at least 70%, at least 80%, at least 90%, at least 95%, at least 98%, or at least 99% the length of the nanofiber (e.g., on average for a plurality of nanofibers). In some embodiments, the continuous matrix material runs along at least 1 micron of the length of the nanofiber (e.g., on average for a plurality of nanofibers). In more specific embodiments, the continuous matrix material runs along at least 10 microns of the length of the nanofiber (e.g., on average for a plurality of nanofibers). In still more specific embodiments, the continuous matrix runs along at least 100 microns of the length of the nanofiber (e.g., on average for a plurality of nanofibers). In yet more specific embodiments, the continuous matrix runs along at least 1 mm of the length of the nanofiber (e.g., on average for a plurality of nanofibers).

In some embodiments, a nanocomposite nanofiber provide herein comprises discrete domains within the nanocomposite nanofiber. In specific embodiments, the discrete domains comprise a silicon material. In certain embodiments, the discrete domains are non-aggregated. In some embodiments, the non-aggregated domains are dispersed, e.g., in a substantially uniform manner, along the length of the nanofiber.

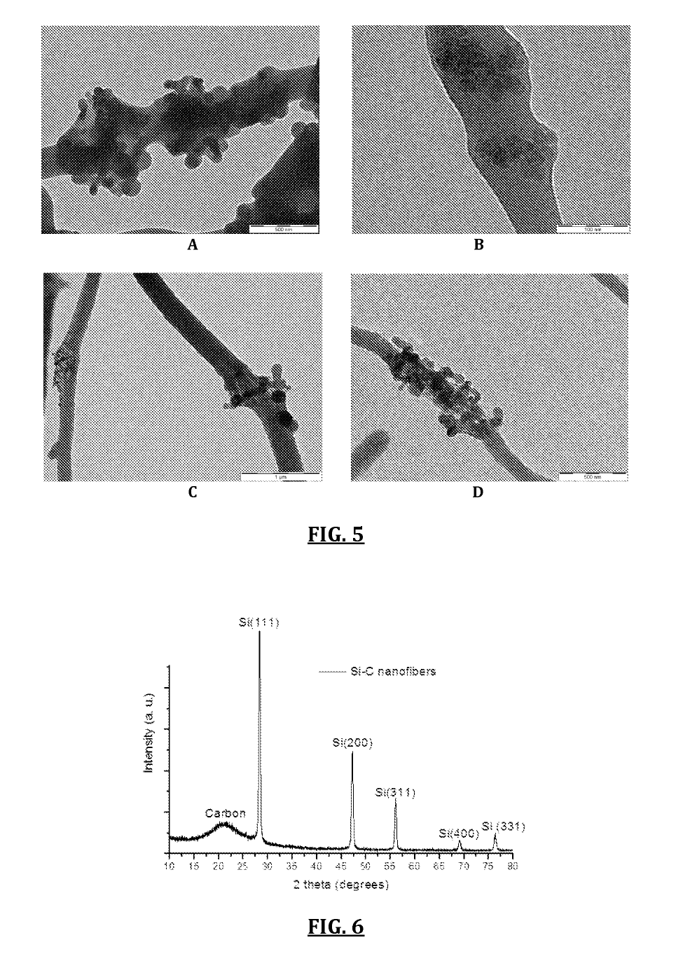

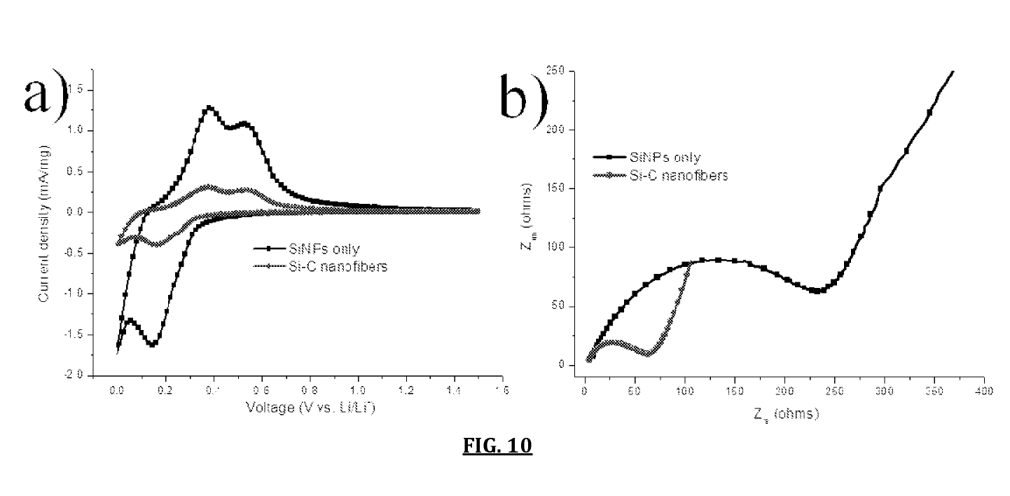

FIG. 4 and FIG. 9 illustrate nanofibers prepared by electrospinning a fluid stock comprising polymer and nanoparticles with a gas-assisted (e.g., coaxially gas assisted) process described herein. FIG. 5 illustrates certain nanofibers prepared by electrospinning a fluid stock comprising polymer and nanoparticles without a gas-assisted process described herein. FIG. 4 and FIG. 9 illustrate non-aggregation of nanoparticles within the matrix/backbone material, whereas FIG. 5 illustrates aggregation of nanoparticles within the matrix material.

In some embodiments, the silicon material domains are non-aggregated. In specific embodiments, the nanofibers comprises less than 50% of domains (e.g., Si nanoparticles) that are aggregated. In specific embodiments, the nanofibers comprises less than 40% of domains (e.g., Si nanoparticles) that are aggregated. In specific embodiments, the nanofibers comprises less than 25% of domains (e.g., Si nanoparticles) that are aggregated. In specific embodiments, the nanofibers comprises less than 10% of domains (e.g., Si nanoparticles) that are aggregated. In specific embodiments, the nanofibers comprises less than 5% of domains (e.g., Si nanoparticles) that are aggregated.

In certain embodiments, the nanocomposite nanofibers provided herein do not comprise a concentration of domains in one segment (e.g., a 500 nm, 1 micron, 1.5 micron, 2 micron) that is over 10 times (e.g., 20 times, 30 times, 50 times, or the like) as concentrated as an immediately adjacent segment. In some embodiments, the segment size for such measurements is a defined length (e.g., 500 nm, 1 micron, 1.5 micron, 2 micron). In other embodiments, the segment size is a function of the average domain (e.g., particle) size (e.g., the segment 5 times, 10 times, 20 times, 100 times the average domain size). In some embodiments, the domains have a (average) size 1 nm to 1000 nm, 1 nm to 500 nm, 1 nm to 200 nm, 1 nm to 100 nm, 20 nm to 30 nm, 1 nm to 20 nm, 30 nm to 90 nm, 40 nm to 70 nm, 15 nm to 40 nm, or the like.

In some embodiments, the nanocomposite nanofibers comprise a plurality of segments (e.g., 0.5 micron, 1 micron, 1.5 micron, 2 micron, or the like) comprising discrete domains (e.g., nanoparticles) described herein, the plurality of segments having an average concentration of discrete domains therein (i.e., domains/particles per segment). In specific embodiments, a majority of the plurality of segments having a concentration of discrete domains within 80% of the average. In more specific embodiments, a majority of the plurality of segments having a concentration of discrete domains within 60% of the average. In yet more specific embodiments, a majority of the plurality of segments having a concentration of discrete domains within 50% of the average. In still more specific embodiments, a majority of the plurality of segments having a concentration of discrete domains within 40% of the average. In in more specific embodiments, a majority of the plurality of segments having a concentration of discrete domains within 30% of the average. In still more specific embodiments, a majority of the plurality of segments having a concentration of discrete domains within 20% of the average. In still more specific embodiments, at least 30%, at least 50%, at least 60%, at least 70%, at least 80%, or at least 90% of the plurality of segments having a concentration of discrete domains within 90%, 80%, 60%, 50%, 40%, 30%, or 20% of the average.

### Silicon Material

In various embodiments, the silicon material in a nanocomposite nanofiber provided herein is any suitable silicon material. In some embodiments, the silicon material is silicon, a silicon alloy (e.g., a silicon metal oxide), or a silicon precursor. In certain embodiments, the silicon material is a material suitable for use in a lithium ion battery anode or negative electrode. In some embodiments, the silicon material is a precursor material capable of being converted into a material suitable for use in a lithium ion battery anode or negative electrode. In various embodiments, the silicon of the silicon material is in a crystalline state. In various embodiments, the silicon of the silicon material is in a zero oxidation state, a positive oxidation state, or a combination thereof. In specific embodiments, the silicon of the silicon material is generally in a zero oxidation state (e.g., a +0 oxidation state, or having an average oxidation state of less than +0.05, on average).

In specific embodiments, a nanocomposite nanofiber provided herein comprises silicon nanoparticles. In specific embodiments, the silicon nanoparticles comprise at least 90 wt. % zero oxidation silicon and less than 10 wt % silicon dioxide. In more specific embodiments, the silicon nanoparticles comprise at least 95 wt. % zero oxidation silicon and less than 5 wt % silicon dioxide. In still more specific embodiments, the silicon nanoparticles comprise 90-99 wt. % zero oxidation silicon and 0.01 (or 0.1) wt % to 5 wt % silicon dioxide.

In certain embodiments, the discrete silicon material domain (e.g., silicon nanoparticle) has an average diameter of less than 200 nm. In specific embodiments, the average diameter is 1 nm to 200 nm. In some embodiments, the average diameter is less than 100 nm. In specific embodiments, the average diameter is 10 nm to 100 nm. In more specific embodiments, the average diameter is 10 nm to 80 nm. In still more specific embodiments, the average diameter is 20 nm to 70 nm.

In certain embodiments, provided herein are nanocomposite nanofibers comprising a silicon material, the silicon material comprising silicon (and other optional elements). In specific embodiments, the nanocomposite nanofibers comprise at least 25% by weight of the silicon material (e.g., on average for a plurality of nanofibers). In more specific embodiments, the nanocomposite nanofibers comprise at least 50% by weight of the silicon material (e.g., on average for a plurality of nanofibers). In still more specific embodiments, the nanocomposite nanofibers comprise at least 60% by weight of the silicon material (e.g., on average for a plurality of nanofibers). In yet more specific embodiments, the nanocomposite nanofibers comprise at least 70% by weight of the silicon material (e.g., on average for a plurality of nanofibers). In specific embodiments, the nanocomposite nanofibers comprise at least 80% by weight of the silicon material (e.g., on average for a plurality of nanofibers).

In certain embodiments, the nanocomposite nanofibers comprise at least 25% by weight of silicon (e.g., on an elemental basis) (e.g., on average for a plurality of nanofibers). In specific embodiments, the nanocomposite nanofibers comprise at least 50% by weight of the silicon (e.g., on average for a plurality of nanofibers). In more specific embodiments, the nanocomposite nanofibers comprise at least 75% by weight of silicon (e.g., on average for a plurality of nanofibers). In yet more specific embodiments, the nanocomposite nanofibers comprise at least 90% by weight of silicon (e.g., on average for a plurality of nanofibers). In specific embodiments, the nanocomposite nanofibers comprise at least 95% by weight of silicon (e.g., on average for a plurality of nanofibers).

In some embodiments, the silicon material comprises silicon, silicon oxide, silicon carbide or a combination thereof. In specific embodiments, the silicon material comprises silicon. In some embodiments, the silicon of the silicon material is substantially in a zero oxidation state. In specific embodiments, at least 50%, at least 60%, at least 70%, at least 80%, at least 90%, at least 95%, or the like of the silicon in the silicon material is in a neutral (zero) oxidation state.

In certain embodiments, the silicon material is or comprises one or more material represented by formula (I):

SiₓSn_{q}M_{y}C_{z} (I)

In some embodiments, M is one or more metal (e.g., Mn, Mo, Nb, W, Ta, Fe, Cu, Ti, V, Cr, Ni, Co, Zr, Y, or a combination thereof). In certain embodiments, (q+x)>2y+z; q≧0, and z≧0. In some embodiments, q, x, y, and z represent atomic percent values. In more specific embodiments, q, x, and y are each ≧0.

### Second Material

In some embodiments, a nanocomposite nanofiber provided herein comprises a silicon material and a second material. In certain embodiments, additional materials are optionally present. In some embodiments, the second materials is a continuous matrix material, as described herein. In certain embodiments, the second material is a second silicon material, as described herein, e.g., silicon and silica. In some embodiments, the second material is a polymer (e.g., an organic polymer, such as a water soluble organic polymer). In other embodiments, the second material is a metal oxide, a ceramic, a metal (e.g., a single metal material or an alloy), carbon, or the like. In some embodiments, the second material comprises at least 3%, at least 5%, at least 10%, at least 15%, at least 20%, at least 30% or the like of the second material (e.g., carbon).

### Nanofibers

In certain embodiments, nanocomposite nanofiber provided herein have any suitable characteristic.

In some embodiments, a nanocomposite nanofiber provided herein has a diameter of less than 2 microns (e.g., an average diameter of a plurality of nanofibers). In specific embodiments, a nanocomposite nanofiber provided herein has a diameter of less than 1.5 microns (e.g., an average diameter of a plurality of nanofibers). In more specific embodiments, a nanocomposite nanofiber provided herein has a diameter of less than 1 micron (e.g., an average diameter of a plurality of nanofibers). In still more specific embodiments, a nanocomposite nanofiber provided herein has a diameter of less than 750 nm (e.g., an average diameter of a plurality of nanofibers). In yet more specific embodiments, a nanocomposite nanofiber provided herein has a diameter of less than 500 nm (e.g., an average diameter of a plurality of nanofibers). In more specific embodiments, a nanocomposite nanofiber provided herein has a diameter of less than 250 nm (e.g., an average diameter of a plurality of nanofibers).

In some embodiments, nanocomposite nanofibers provided herein have a (e.g., average) length of at least 1 μm, at least 10 μm, at least 20 μm, at least 100 μm, at least 500 μm, at least 1,000 μm, at least 5,000 μm, at least 10,000 μm, or the like.

In some embodiments, a nanocomposite nanofiber provided herein has an aspect ratio of greater than 10 (e.g., an average aspect ratio of a plurality of nanofibers). In specific embodiments, a nanocomposite nanofiber provided herein has an aspect ration of greater than 100 (e.g., an average aspect ratio of a plurality of nanofibers). In more specific embodiments, a nanocomposite nanofiber provided herein has an aspect ration of greater than 500 (e.g., an average aspect ratio of a plurality of nanofibers). In still more specific embodiments, a nanocomposite nanofiber provided herein h has an aspect ration of greater than 1000 (e.g., an average aspect ratio of a plurality of nanofibers). In yet more specific embodiments, a nanocomposite nanofiber provided herein has an aspect ration of greater than 10⁴ (e.g., an average aspect ratio of a plurality of nanofibers).

In some embodiments, the nanocomposite nanofiber is crosslinked. In specific instances, the second material (e.g., non-silicon containing second material) of the nanocomposite nanofiber provided herein is crosslinked with the second material of one or more adjacent nanofiber.

In some embodiments, nanofibers provided herein comprise (e.g., on average) at least 99%, at least 98%, at least 97%, at least 96%, at least 95%, at least 90%, at least 80%, or the like of metal, oxygen and carbon, when taken together, by mass (e.g., elemental mass). In specific embodiments, nanofibers (e.g., on average) provided herein comprise at least 99%, at least 98%, at least 97%, at least 96%, at least 95%, at least 90%, at least 80%, or the like of metal and oxygen, when taken together, by mass (e.g., elemental mass). In some embodiments, nanofibers provided herein comprise (e.g., on average) at least 99%, at least 98%, at least 97%, at least 96%, at least 95%, at least 90%, at least 80%, or the like of silicon, oxygen and carbon, when taken together, by mass (e.g., elemental mass). In specific embodiments, nanofibers (e.g., on average) provided herein comprise at least 99%, at least 98%, at least 97%, at least 96%, at least 95%, at least 90%, at least 80%, or the like of silicon and carbon, when taken together, by mass (e.g., elemental mass).

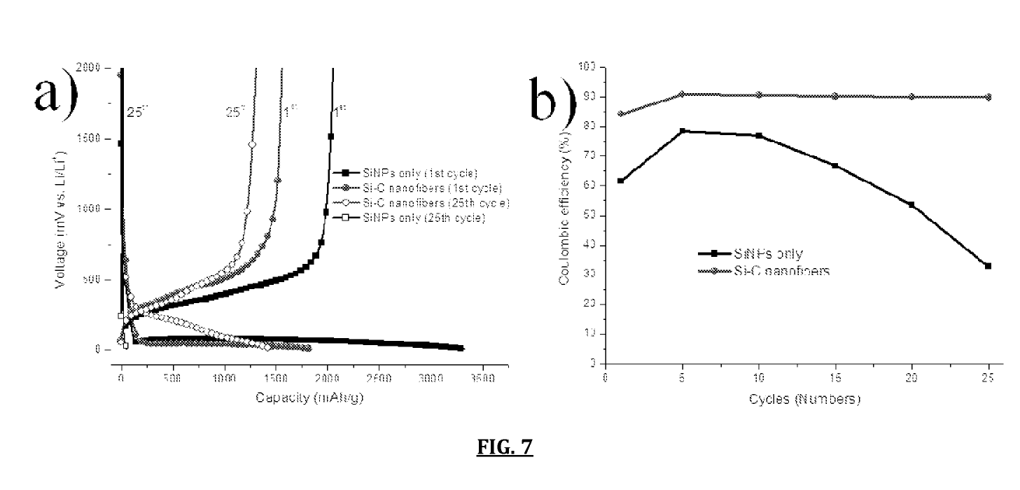

In specific embodiments, provided herein is a nanocomposite nanofibers comprising a backbone (e.g., a continuous matrix material, such as a continuous core matrix), the backbone comprising nanoparticles embedded therein, the backbone comprising carbon and the nanoparticles comprising silicon. In more specific embodiments, the nanofiber has an X-Ray diffraction (XRD) pattern similar or identical to that forth in FIG. 6. In some embodiments, the nanofiber has an XRD pattern with at least 3 of the peaks in the XRD pattern set forth in FIG. 6. In some embodiments, the nanofiber has an XRD pattern with at least 4 of the peaks in the XRD pattern set forth in FIG. 6. In some embodiments, the nanofiber has an XRD pattern with at least 5 of the peaks in the XRD pattern set forth in FIG. 6. In some embodiments, the nanofiber has an XRD pattern with at least 3 of the following peaks: 28.37°±0.03, 47.20°±0.03, 56.09°±0.03, 69.02°±0.03, and 76.37°±0.03. In certain embodiments, the nanofiber has an XRD pattern with at least 4 of the following peaks: 28.37°±0.03, 47.20°±0.03, 56.09°±0.03, 69.02°±0.03, and 76.37°±0.03. In some embodiments, the nanofiber has an XRD pattern with at least 5 of the following peaks: 28.37°±0.03, 47.20°±0.03, 56.09°±0.03, 69.02°±0.03, and 76.37°±0.03.

In some embodiments, the porosity of a nanofiber mat (comprising one or more nanofiber described herein) is at least 5%, at least 10%, at least 15%, at least 20%, at least 25%, at least 50%, or the like. Porosity can be measured in any suitable manner. For example, in some instances, the porosity of a nanofiber mat is determined by measuring the fluid volume present in the nanofiber mat after the nanofiber mat is submerged in or filled with a fluid.

Described herein are nanofibers and methods for making nanofibers that have a plurality of pores. The pores may be of any suitable size or shape. In some embodiments the pores are “mesopores”, having a diameter of less than 100 nm (e.g., between 2 and 50 nm, on average). In some embodiments, the pores are “ordered”, such as having a substantially uniform shape, a substantially uniform size and/or are distributed substantially uniformly through the nanofiber. In some embodiments, nanofibers described herein have a high surface area and/or specific surface area (e.g., surface area per mass of nanofiber and/or surface area per volume of nanofiber). In some embodiments, nanofibers described herein comprise ordered pores, e.g., providing substantially flexible and/or non-brittleness.

In one aspect, described herein are nanofibers comprising any one or more of: (a) a surface area of at least 10 π r h, wherein r is the radius of the nanofiber and h is the length of the nanofiber; (b) a specific surface area of at least 10 m²/g (e.g., at least 100 m²/g); (c) a porosity of at least 20% and a length of at least 1 μm; (d) a porosity of at least 35%, wherein the nanofiber is substantially contiguous; (e) a porosity of at least 35%, wherein the nanofiber is substantially flexible or non-brittle; (f) a plurality of pores with an average diameter of at least 1 nm; (g) a plurality of pores, wherein the pores have a substantially uniform shape; (h) a plurality of pores, wherein the pores have a substantially uniform size; and (i) a plurality of pores, wherein the pores are distributed substantially uniformly throughout the nanofiber.

In some embodiments, the pores comprise spheres, cylinders, layers, channels, or any combination thereof. In some embodiments, the pores are helical. In some embodiments, the nanofiber comprises metal, metal alloy, ceramic, polymer, or any combination thereof.

In one aspect, described herein is a method for producing an ordered mesoporous nanofiber, the method comprising: (a) coaxially electrospinning a first fluid stock with a second fluid stock to produce a first nanofiber, the first fluid stock comprising at least one block co-polymer and a silicon component (e.g., silicon precursor), the second fluid stock comprising a coating agent, and the first nanofiber comprising a first layer (e.g., core) and a second layer (e.g., coat) that at least partially coats the first layer; (b) annealing the first nanofiber; (c) optionally removing the second layer from the first nanofiber to produce a second nanofiber comprising the block co-polymer; and (d) selectively removing at least part of the block co-polymer from the first nanofiber or the second nanofiber (e.g. thereby producing an ordered mesoporous nanofiber). Additional coaxial layers are optional—e.g., comprising a precursor and block copolymer for an additional mesoporous layer, or a precursor and a polymer as described herein for a non-mesoporous layer.

In some embodiments, the block co-polymer comprises a polyisoprene (PI) block, a polylactic acid (PLA) block, a polyvinyl alcohol (PVA) block, a polyethylene oxide (PEO) block, a polyvinylpyrrolidone (PVP) block, polyacrylamide (PAA) block or any combination thereof (i.e., thermally or chemically degradable polymers). In some embodiments, the block co-polymer comprises a polystyrene (PS) block, a poly(methyl methacrylate) (PMMA) block, a polyacrylonitrile (PAN) block, or any combination thereof. In some embodiments, the coating layer and at least part of the block co-polymer (concurrently or sequentially) is selectively removed in any suitable manner, such as, by heating, by ozonolysis, by treating with an acid, by treating with a base, by treating with water, by combined assembly by soft and hard (CASH) chemistries, or any combination thereof. Additionally, U.S. Application Ser. No. 61/599,541 and International Application Ser. No. PCT/US13/26060, filed Feb. 14, 2013 is incorporated herein by reference for disclosures related to such techniques.

### Batteries and Electrodes

In some embodiments, provided herein is a battery (e.g., a primary or secondary cell) comprising at least one nanofiber described herein. In specific instances, the battery comprises plurality of such nanofibers, e.g., a non-woven mat thereof. In some embodiments, the battery comprises at least two electrodes (e.g., an anode and a cathode) and a separator, at least one of the electrodes comprising at least one nanofiber described herein. In specific embodiments, the battery is a lithium-ion battery and the anode comprises at least one nanofiber described herein (e.g., a nanofiber mat thereof). Likewise, provided herein is an electrode comprising any nanocomposite nanofiber described herein (e.g., a nanofiber mat comprising one or more such nanofibers).

In some embodiments, the batteries comprise a negative electrode (anode) comprising a plurality of nanocomposite nanofibers described herein. In specific embodiments, the negative electrode or plurality of nanocomposite nanofibers have a discharge capacity or specific energy capacity of at least 1500 mAh/g on a first cycle at 0.1 C (e.g., as determined by half cell or full cell testing). In further or alternative embodiments, the negative electrode or plurality of nanocomposite nanofibers have a discharge capacity or specific energy capacity of at least 2000 mAh/g on a first cycle at 0.1 C. In further or alternative embodiments, the negative electrode or plurality of nanocomposite nanofibers have a discharge capacity or specific energy capacity of at least 1400 mAh/g on a 10th cycle at 0.1 C. In further or alternative embodiments, the negative electrode or plurality of nanocomposite nanofibers have a discharge capacity or specific energy capacity of at least 1800 mAh/g on a 10th cycle at 0.1 C. In further or alternative embodiments, the negative electrode or plurality of nanocomposite nanofibers have a discharge capacity or specific energy capacity of at least 1000 mAh/g on a 50th cycle at 0.1 C. In further or alternative embodiments, the negative electrode or plurality of nanocomposite nanofibers have a discharge capacity or specific energy capacity of at least 1600 mAh/g on a 50th cycle at 0.1 C. In further or alternative embodiments, the negative electrode or plurality of nanocomposite nanofibers have a discharge capacity or specific energy capacity of at least 250 mAh/g on a 98th cycle at 0.1 C. In further or alternative embodiments, the negative electrode or plurality of nanocomposite nanofibers have a discharge capacity or specific energy capacity of at least 400 mAh/g on a 98th cycle at 0.1 C.

In certain embodiments, provided herein is a negative electrode comprising silicon (e.g., silicon nanoparticles) or a plurality of nanocomposite nanofibers having an discharge capacity or specific energy capacity on a 25^{th} cycle at 0.1 C that is at least 40% of the discharge capacity or specific energy capacity on the 1^{st} cycle at 0.1 C. In further or alternative embodiments, provided herein is a negative electrode comprising silicon nanoparticles or plurality of nanocomposite nanofibers having an discharge capacity or specific energy capacity on a 25^{th} cycle at 0.1 C that is at least 50% of the discharge capacity or specific energy capacity on the 1^{st} cycle at 0.1 C. In certain embodiments, provided herein is a negative electrode comprising silicon (e.g., silicon nanoparticles) or plurality of nanocomposite nanofibers having an discharge capacity or specific energy capacity on a 98^{th} cycle at 0.1 C that is at least 10% of the discharge capacity or specific energy capacity on the 1^{st} cycle at 0.1 C. In further or alternative embodiments, provided herein is a negative electrode comprising silicon nanoparticles or plurality of nanocomposite nanofibers having an discharge capacity or specific energy capacity on a 98^{th} cycle at 0.1 C that is at least 20% of the discharge capacity or specific energy capacity on the 1^{st} cycle at 0.1 C. In certain embodiments, provided herein is a negative electrode comprising silicon (e.g., silicon nanoparticles) or plurality of nanocomposite nanofibers having an discharge capacity or specific energy capacity on a 98^{th} cycle at 0.1 C that is at least 20% of the discharge capacity or specific energy capacity on the 10^{th} cycle at 0.1 C. In further or alternative embodiments, provided herein is a negative electrode comprising silicon nanoparticles or plurality of nanocomposite nanofibers having an discharge capacity or specific energy capacity on a 98^{th} cycle at 0.1 C that is at least 30% of the discharge capacity or specific energy capacity on the 10^{th} cycle at 0.1 C.

In some embodiments, negative electrodes provided herein are prepared by depositing high energy (anodic) capacity nanofibers onto a current collector, thereby creating a negative electrode comprising the nanofibers in contact with a current collector. In certain embodiments, as-treated nanofibers are ground in a mortal and pestle to produce processed nanofibers, which are then deposited on a current collector. In some embodiments, the processed nanofibers are dispersed in a solvent to prepare a composition, the composition is deposited onto a current collector, and evaporation of the solvent results in formation of an electrode on the current collector. In specific embodiments, the composition further comprises a binder. In further or alternative specific embodiments, the composition further comprises a conductive material (e.g., carbon black)—e.g., to improve electron mobility.

FIG. 7 illustrates charge/discharge curves of 1^{st} cycle and 25^{th} cycle (panel A) and plotted curves of Coulombic efficiencies (panel B) for Si/C nanocomposite nanofibers provided herein compared against Si nanoparticles alone. In some embodiments, provided herein is a plurality of nanocomposite nanofibers or a negative electrode comprising Si nanoparticles having a capacity at least as great as set forth in FIG. 7. In some embodiments, provided herein is a Si containing negative electrode or plurality of nanocomposite nanofibers having a Coulombic efficiency of at least 80% over 25 cycles. In some embodiments, provided herein is a Si containing negative electrode or plurality of nanocomposite nanofibers having a Coulombic efficiency of at least 90% over 25 cycles.

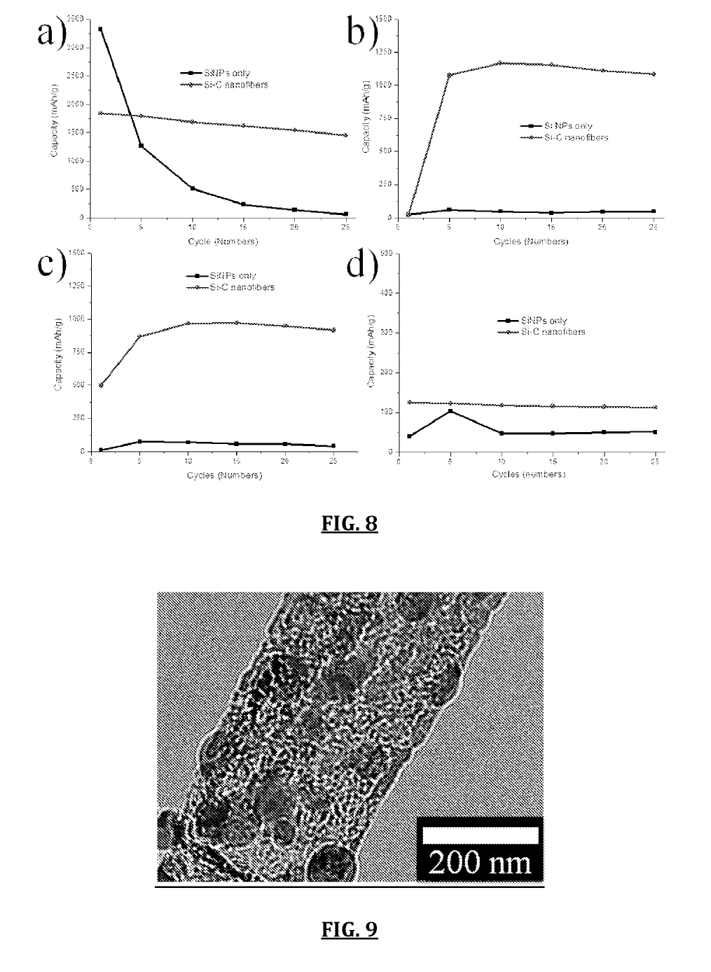

FIG. 8 illustrates plotted graphs of discharge capacities of silicon nanoparticles in carbon nanocomposite nanofibers provided herein compared to silicon nanoparticles alone at various discharge rates. In certain embodiments, a nanocomposite nanofiber provided herein has a discharge capacity at least as great as the values set forth in FIG. 8 at any given cycle number or discharge rate. In certain embodiments, provided herein is a nanocomposite nanofiber having a discharge capacity of at least 1450 mAh/g (e.g., after 25 cycles) at 0.1 C. In some embodiments provided herein is a nanocomposite nanofiber having a discharge capacity of at least 1150 mAh/g (e.g., after 25 cycles) at 0.5 C. In some embodiments, provided herein is a nanocomposite nanofiber having a discharge capacity of at least 1000 mAh/g (e.g., after 25 cycles) at a discharge rate of 0.8 C.

FIG. 10 illustrates cyclic voltammograms (panel A) and Nyquist plots (panel B) of silicon nanoparticles and certain Si/C nanocomposite nanofibers described herein. In specific embodiments, the charge transport resistance (e.g., as determined from AC impedance) of a nanocomposite described herein is as demonstrated in FIG. 10. In some embodiments, the charge transport resistance of a nanocomposite nanofiber described herein is less than 100Ω. In specific embodiments, the charge transport resistance of a nanocomposite nanofiber described herein is less than 75Ω. In more specific embodiments, the charge transport resistance of a nanocomposite nanofiber described herein is less than 65Ω. In specific embodiments, the charge transport resistance of a nanocomposite nanofiber described herein is less than 60Ω. In further or alternative embodiments, the solution (polarization) resistance of a nanocomposite nanofiber provided herein is less than 5 μl (e.g., compared to 7.4 μl of pure silicon nanoparticles). In specific embodiments, the solution (polarization) resistance of a nanocomposite nanofiber provided herein is less than 4Ω. In more specific embodiments, the solution (polarization) resistance of a nanocomposite nanofiber provided herein is less than 3.5Ω.

### Process

In certain embodiments, provided herein is a process for preparing silicon containing nanocomposite nanofibers. In some embodiments, such silicon containing nanocomposite nanofibers comprise high amounts of silicon (e.g., as described herein). Moreover, in some embodiments, provided herein are high quality nanofibers and processes for preparing high quality nanofibers that have good structural integrity, few voids, few structural defects, tunable length, and the like. In certain embodiments, high loading of precursor or other silicon component, relative to polymer loading, in the fluid stock and/or precursor/electrospun nanofibers, facilitates and/or provides such high quality nanofibers.

In some embodiments, the electrospun nanofiber comprising a silicon material and a polymer is prepared by electrospinning a fluid stock, the fluid stock comprising (1) a silicon component; and (2) polymer. In specific embodiments, the silicon component comprises a silicon precursor, a silicon containing nanoparticle (e.g., a nanoparticle comprising a silicon, silica, a silicon material of formula (I), or any combination thereof). In more specific embodiments, the silicon component is a silicon precursor (e.g., silicon acetate). In other specific embodiments, the silicon component is a nanoparticle.

In specific embodiments, the process further comprises treating the as-spun nanocomposite nanofiber (e.g., comprising polymer, silicon component (optionally a silicon precursor—the precursor, which may be in association with the polymer or another radical or ligand/anion—and/or silicon containing nanoparticle), and a metal precursor (which, likewise, may be in association with the polymer or another group or anion).

In other specific embodiments, the electrospun nanofiber comprising a silicon component and a polymer is prepared by electrospinning a fluid stock, the fluid stock comprising (1) a plurality of nanoparticles comprising a silicon containing nanofiber; and (2) polymer (e.g., a water soluble polymer).

In specific embodiments, the fluid stock comprises an aqueous medium (e.g., water or an aqueous mixture, such as water/alcohol, water/acetic acid, or the like).

In some embodiments, the treatment process comprises (a) thermal treatment; (b) chemical treatment; or (c) a combination thereof. In specific embodiments, treatment of the as-spun nanocomposite nanofiber comprises thermally treating the as-spun nanocomposite nanofiber under oxidative conditions (e.g., air). In other specific embodiments, treatment of the as-spun nanocomposite nanofiber comprises thermally treating the as-spun nanocomposite nanofiber under inert conditions (e.g., argon). In still other specific embodiments, treatment of the as-spun nanocomposite nanofiber comprises thermally treating the as-spun nanocomposite nanofiber under reducing conditions (e.g., hydrogen, or a hydrogen/argon blend). In certain embodiments, the as-spun nanofiber is heated to a temperature of about 500° C. to about 2000° C., at least 900° C., at least 1000° C., or the like. In specific embodiments, the as-spun nanofiber is heated to a temperature of about 1000° C. to about 1800° C., or about 1000° C. to about 1700° C. In specific embodiments, the thermal treatment step is at 600° C. to 1200° C. In more specific embodiments, the thermal treatment step is at 700° C. to 1100° C. In still more specific embodiments, the thermal treatment step is at 800° C. to 1000° C. (e.g., in an inert or reducing atmosphere).

In one aspect, the process has a high yield (e.g., which is desirable for embodiments in which the precursor is expensive). In some embodiments, the metal atoms in the nanofiber are about 3%, about 10%, about 20%, about 30%, about 33%, about 40%, about 50%, about 60%, about 70%, about 80%, about 90%, about 95%, about 98%, or about 100% of the number of (e.g., in moles) metal (i.e., silicon and other metal) molecules in the fluid stock.

In some embodiments, the fluid stock uniform or homogenous. In specific embodiments, the process described herein comprises maintaining fluid stock uniformity or homogeneity. In some embodiments, fluid stock uniformity and/or homogeneity is achieved or maintained by any suitable mechanism, e.g., by agitating, heating, or the like. Methods of agitating include, by way of non-limiting example, mixing, stirring, shaking, sonicating, or otherwise inputting energy to prevent or delay the formation of more than one phase in the fluid stock.

In some embodiments, (e.g., where metal precursors are utilized, such as a silicon precursor and one or more additional metal precursor) the weight ratio of the metal component(s) (including silicon and other metal components, such as silicon and metal precursors) to polymer is at least 1:5, at least 1:4, at least 1:3, at least 1:2, at least 1:1, at least 1.25:1, at least 1.5:1, at least 1.75:1, at least 2:1, at least 3:1, or at least 4:1. In some instances, wherein the silicon component of a process described herein is a preformed silicon nanoparticle, the silicon component to polymer weight ratio is at least 1:5, at least 1:4, at least 1:3, at least 1:2, or the like. In some instances, wherein the silicon component of a process described herein is a silicon precursor, the silicon component to polymer ratio is at least 1:3, at least 1:2, at least 1:1, or the like. In some embodiments, the monomeric residue (i.e., repeat unit) concentration of the polymer in the fluid stock is at least 100 mM. In specific embodiments, the monomeric residue (i.e., repeat unit) concentration of the polymer in the fluid stock is at least 200 mM. In more specific embodiments, the monomeric residue (i.e., repeat unit) concentration of the polymer in the fluid stock is at least 400 mM. In still more specific embodiments, the monomeric residue (i.e., repeat unit) concentration of the polymer in the fluid stock is at least 500 mM. In some embodiments, the fluid stock comprises at least about 0.5 weight %, at least about 1 weight %, at least about 2 weight %, at least about 5 weight %, at least about 10 weight %, or at least about 20 weight polymer.

In some embodiments, the optional or additional metal precursor comprises an alkali metal salt or complex, an alkaline earth metal salt or complex, a transition metal salt or complex, or the like. In specific embodiments, the optional or additional metal precursor comprises an iron precursor, a nickel precursor, a cobalt precursor, a manganese precursor, a vanadium precursor, a titanium precursor, a ruthenium precursor, a rhenium precursor, a platinum precursor, a bismuth precursor, a lead precursor, a copper precursor, an aluminum precursor, or the like. In specific embodiments, the optional or additional metal precursor comprises a molybdenum precursor, niobium precursor, tantalum precursor, tungsten precursor, iron precursor, nickel precursor, copper precursor, cobalt precursor, manganese precursor, titanium precursor, vanadium precursor, chromium precursor, zirconium precursor, yttrium precursor, or a combination thereof. In specific embodiments, metal (silicon and other metals) precursors include metal salts or complexes, wherein the metal is associated with any suitable ligand or radical, or anion or other Lewis Base, e.g., a carboxylate (e.g., —OCOCH₃ or another—OCOR group, wherein R is an alkyl, substituted alkyl, aryl, substituted aryl, or the like, such as acetate), an alkoxide (e.g., a methoxide, ethoxide, isopropyl oxide, t-butyl oxide, or the like), a halide (e.g., chloride, bromide, or the like), a diketone (e.g., acetylacetone, hexafluoroacetylacetone, or the like), a nitrates, amines (e.g., NR′₃, wherein each R″ is independently R or H or two R″, taken together form a heterocycle or heteroaryl), and combinations thereof.

In some embodiments, a polymer in a process or nanocomposite nanofiber described herein is an organic polymer. In some embodiments, polymers used in the compositions and processes described herein are hydrophilic polymers, including water-soluble and water swellable polymers. In some aspects, the polymer is soluble in water, meaning that it forms a solution in water. In other embodiments, the polymer is swellable in water, meaning that upon addition of water to the polymer the polymer increases its volume up to a limit. Exemplary polymers suitable for the present methods include but are not limited to polyvinyl alcohol (“PVA”), polyvinyl acetate (“PVAc”), polyethylene oxide (“PEO”), polyvinyl ether, polyvinyl pyrrolidone, polyglycolic acid, hydroxyethylcellulose (“HEC”), ethylcellulose, cellulose ethers, polyacrylic acid, polyisocyanate, and the like. In some embodiments, the polymer is isolated from biological material. In some embodiments, the polymer is starch, chitosan, xanthan, agar, guar gum, and the like. In other instances, e.g., wherein silicon nanoparticles are utilized as the silicon component, other polymers, such as polyacrylonitrile (“PAN”) are optionally utilized (e.g., with DMF as a solvent). In other instances, a polyacrylate (e.g., polyalkacrylate, polyacrylic acid, polyalkylalkacrylate, or the like) is optionally utilized.

Polymers of any suitable molecular weight may be utilized in the processes and nanofibers described herein. In some instances, a suitable polymer molecular weight is a molecular weight that is suitable for electrospinning the polymer as a melt or solution (e.g., aqueous solution or solvent solution—such as in dimethyl formamide (DMF) or alcohol). In some embodiments, the polymer utilized has an average atomic mass of 1 kDa to 1,000 kDa. In specific embodiments, the polymer utilized has an average atomic mass of 10 kDa to 500 kDa. In more specific embodiments, the polymer utilized has an average atomic mass of 10 kDa to 250 kDa. In still more specific embodiments, the polymer utilized has an average atomic mass of 50 kDa to 200 kDa.

In some embodiments, a polymer described herein (e.g., in a process, precursor nanofiber, a fluid stock, or the like) is a polymer (e.g., homopolymer or copolymer) comprising a plurality of reactive sites. In certain embodiments, the reactive sites are nucleophilic (i.e., a nucleophilic polymer) or electrophilic (i.e., an electrophilic polymer). For example, in some embodiments, a nucleophilic polymer described herein comprises a plurality of alcohol groups (such as polyvinyl alcohol—PVA—or a cellulose), ether groups (such as polyethylene oxide—PEO—or polyvinyl ether—PVE), and/or amine groups (such as polyvinyl pyridine, ((di/mono)alkylamino)alkyl alkacrylate, or the like).

In certain embodiments, the polymer is a nucleophilic polymer (e.g., a polymer comprising alcohol groups, such as PVA). In some embodiments, the polymer is a nucleophilic polymer and a silicon and/or optional metal precursor is an electrophilic precursor (e.g., a metal acetate, metal chloride, or the like). In specific embodiments, the nucleophilic polymer and the precursor form a precursor-polymer association in the fluid stock and/or the as-spun nanocomponsite nanofiber and that association is a reaction product between a nucleophilic polymer and electrophilic precursor(s).

In other embodiments, the polymer is an electrophilic polymer (e.g., a polymer comprising chloride or bromide groups, such as polyvinyl chloride). In some embodiments, the polymer is an electrophilic polymer and a precursor (e.g., silicon and/or optional metal precursor) is a nucleophilic precursor (e.g., metal-ligand complex comprising “ligands” with nucleophilic groups, such as alcohols or amines). In specific embodiments, the nucleophilic polymer and the precursor form a precursor-polymer association in the fluid stock and/or the as-spun nanocomponsite nanofiber and that association is a reaction product between an electrophilic polymer and a nucleophilic first precursor.

For the purposes of this disclosure metal precursors include both preformed metal-ligand associations (e.g., salts, metal-complexes, or the like) (e.g., reagent precursors, such as metal acetates, metal halides, or the like) and/or metal-polymer associations (e.g., as formed following combination of reagent precursor with polymer in an aqueous fluid).

### Electrospinning

In some embodiments, the process comprises electrospinning a fluid stock. Any suitable method for electrospinning is used.

In some instances, elevated temperature electrospinning is utilized. Exemplary methods for comprise methods for electrospinning at elevated temperatures as disclosed in U.S. Pat. No. 7,326,043 and U.S. Pat. No. 7,901,610, which are incorporated herein for such disclosure. In some embodiments, elevated temperature electrospinning improves the homogeneity of the fluid stock throughout the electrospinning process.

In some embodiments, gas assisted electrospinning is utilized (e.g., about a common axis with the jet electrospun from a fluid stock described herein). Exemplary methods of gas-assisted electrospinning are described in PCT Patent Application PCT/US2011/024894 (“Electrospinning apparatus and nanofibers produced therefrom”), which is incorporated herein for such disclosure. In gas-assisted embodiments, the gas is optionally air or any other suitable gas (such as an inert gas, oxidizing gas, or reducing gas). In some embodiments, gas assistance increases the throughput of the process and/or reduces the diameter of the nanofibers. In some instances, gas assisted electrospinning accelerates and elongates the jet of fluid stock emanating from the electrospinner. In some instances, gas assisted electrospinning disperses silicon material in nanocomposite nanofibers. For example, in some instances, gas assisted electrospinning (e.g., coaxial electrospinning of a gas—along a substantially common axis—with a fluid stock comprising Si nanoparticles) facilitates dispersion or non-aggregation of the Si nanoparticles in the electrospun jet and the resulting as-spun nanofiber (and subsequent nanofibers produced therefrom). In some embodiments, incorporating a gas stream inside a fluid stock produces hollow nanofibers. In some embodiments, the fluid stock is electrospun using any suitable technique.

In specific embodiments, the process comprises coaxial electrospinning (electrospinning two or more fluids about a common axis). As described herein, coaxial electrospinning a first fluid stock as described herein (e.g., comprising a silicon component and a polymer) with a second fluid is used to add coatings, make hollow nanofibers, make nanofibers comprising more than one material, and the like. In various embodiments, the second fluid is either outside (i.e., at least partially surrounding) or inside (e.g., at least partially surrounded by) the first fluid stock. In some embodiments, the second fluid is a gas (gas-assisted electrospinning). In some embodiments, gas assistance increases the throughput of the process, reduces the diameter of the nanofibers, and/or is used to produce hollow nanofibers. In some embodiments, the method for producing nanofibers comprises coaxially electrospinning the first fluid stock and a gas. In other embodiments, the second fluid is a second fluid stock and comprises a polymer and an optional metal component (e.g., a silicon and/or non-silicon metal component).

Also, provided in some instances herein is a hollow silicon nanofiber. In some instances, such a nanofiber is prepared according to the process herein, by electrospinning a fluid stock comprising a silicon precursor and a polymer (e.g., a water soluble in an aqueous fluid). In certain embodiments, the fluid stock is coaxially spun with a gas as the core. For example, referring to FIG. 1 wherein 111 is the electrospinning nozzle (needle apparatus), in some instances 112 is a tube or needle for providing a gas, 113 is a tube or needle for providing a fluid stock, and 114 is an optional tube for providing an additional gas (which may be the same or different from the gas provided via 112. In some instances, following electrospinning, the as-spun nanofiber (e.g., comprising silicon precursor and polymer, the silicon precursor optionally being a radical attached to the polymer) is thermally treated (e.g., under inert or reducing conditions) according to a process described herein. In some embodiments, such a hollow silicon nanofiber has an aspect ratio, diameter, or length as described herein. In some instances, the outer needle 112 is optionally absent.

### EXAMPLES

### Example 1

### Preparing a Fluid Stock of Silicon Nanoparticles and PVA

0.5 grams of preformed silicon nanoparticles (100 nm average diameter), the silicon component, is suspended in 20 ml of 1 molar acetic acid solution with X-100 surfactant. The solution is stirred for 2 hours to create a suspension of silicon nanoparticles.

In a second solution, 1 gram of 99.7% hydrolyzed polyvinyl alcohol (PVA) with an average molecular weight of 79 kDa and polydispersity index of 1.5 is dissolved in 10 ml of de-ionized water. The polymer solution is heated to a temperature of 95° C. and stirred for 2 hours to create a homogenous solution.

The silicon nanoparticle suspension is then combined with the PVA solution to create a fluid stock. In order to distribute the nanoparticles substantially evenly in the fluid stock, the nanoparticle suspension is added gradually to the polymer solution while being continuously vigorously stirred for 2 hours. The mass ratio of nanoparticles to polymer for the fluid feed (based on silicon nanoparticle mass) is 1:4.

### Example 2

### Preparing Silicon/Polymer and Silicon/Carbon Nanocomposite Nanofiber

The fluid stock is co-axially electrospun with gas using a coaxial needle apparatus similar to the one depicted in FIG. 1 (where 111 illustrates the needle apparatus). The center conduit contains silicon suspension fluid stock of Example 1 and the outer conduit contains air (the intermediate tube in 111 (i.e., 113) in FIG. 1 may be absent, not used, provides additional gas flow, etc.). The electrospun hybrid fluid stock (hybrid as-spun nanofiber) is calcinated by heating for 2 hours at 600° C. in an inert atmosphere (e.g., argon).

FIG. 4 illustrates silicon/polymer and silicon/carbon nanocomposite nanofibers prepared according to a method such as set for above. Panel A illustrates an SEM image of the as-spun polymer/Si nanoparticle nanocomposite nanofibers. Panel B illustrates an SEM image of the heat treated carbon/Si nanoparticle nanocomposite nanofibers. Panel C illustrates a TEM image of the heat-treated carbon/Si nanoparticle nanocomposite nanofibers.

### Example 3

### Silicon Nanocomposite Nanofibers—Thermal Treatment

Fluid stock: 0.5 g PVA (88% hydrolyzed, 78 kDa) was combined with 4.5 g water and heated at 95 C for at least 8 hours. Silicon nanoparticles (purchased from Silicon and Amorphous Materials, Inc., 20-30 nm (actual average size about 50 nm)) added to the polymer solution and sonicated at room temperature for 4 hours. Heated and mixed at 50 C for 4 hours. Silicon nanoparticles are added in ratios of polymer:Si of 2:1.

Nanofibers: the fluid stock is gas-assisted electrospun from a needle apparatus having an inner needle and an outer needle coaxially aligned, the inner needle providing the fluid stock, the outer needle providing the gas. The fluid stock is provided at a flow rate of 0.01 mL/min; the voltage used is 20 kV, the needle apparatus tip to collector distance is 15 cm.

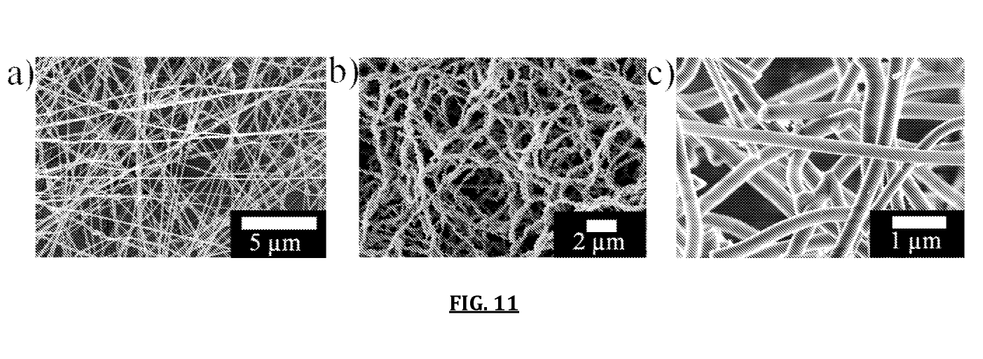

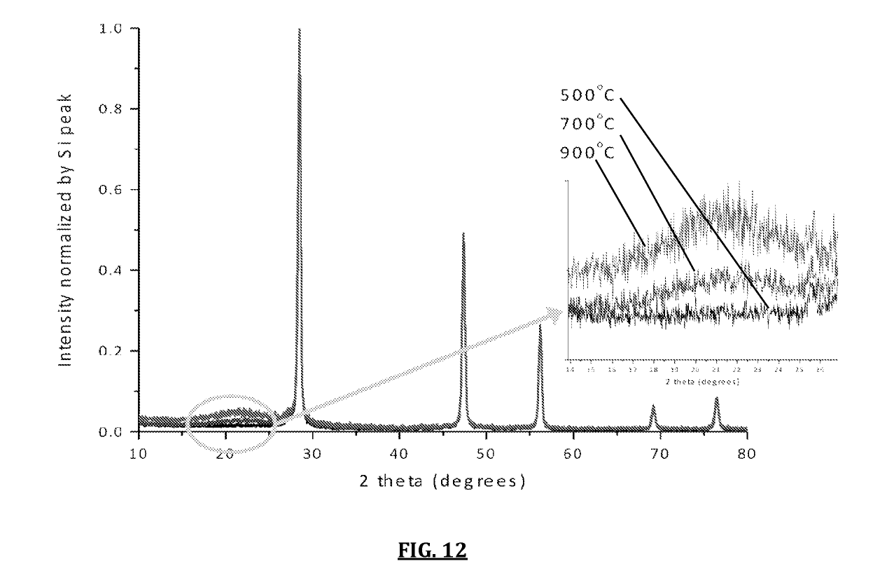

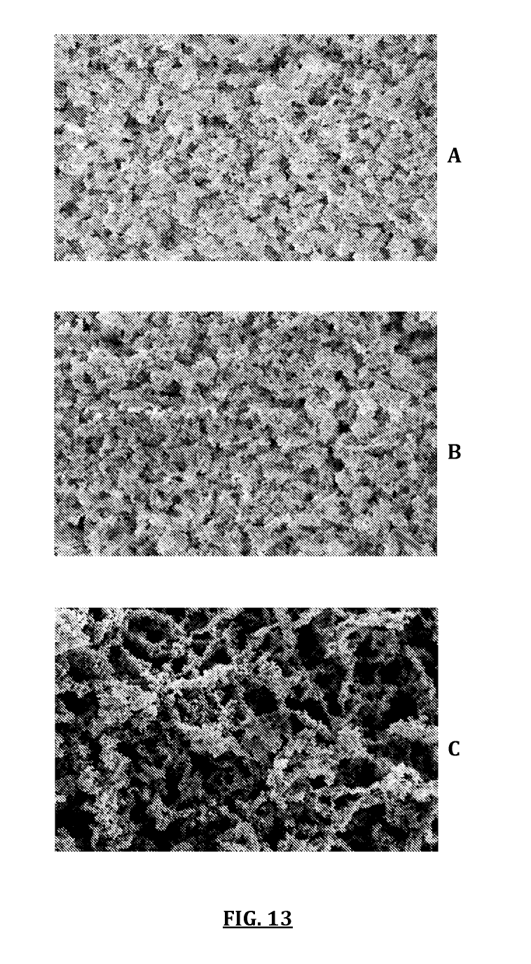

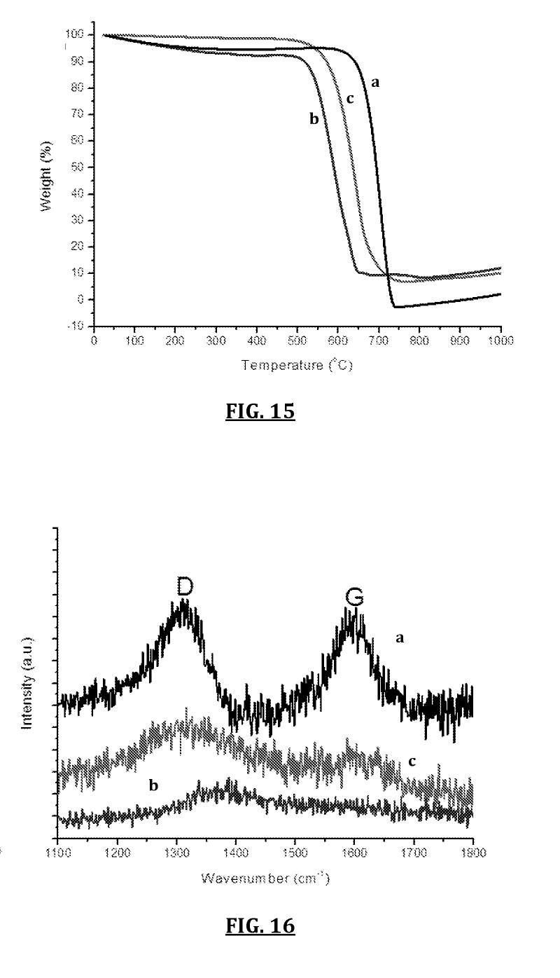

The electrospun nanofiber is a polymer-Si (nanoparticle) nanocomposite nanofiber illustrated in FIG. 11 (Panel A). The nanofibers are then treated with heat under Argon: at 500° C., 700° C., 900° C., and 1200° C. (heat and cool rate of 2° C./minute). FIG. 11 (panel B) illustrates an SEM image of a silicon/carbon nanocomposite nanofiber prepared by treatment at 900° C.; FIG. 11 (panel C) illustrates an SEM image of a silicon/carbon nanocomposite nanofiber prepared by treatment at 1200° C. FIG. 12 illustrates normalized XRD peaks for the nanocomposite nanofibers prepared at 500, 700, and 900° C. FIG. 13 illustrates SEM images for silicon/carbon nanocomposite nanofibers prepared by treatment at 500° C. (panel A), 700° C. (panel B), and 900° C. (panel C). FIG. 9 illustrates a TEM image for silicon/carbon nanocomposite nanofibers prepared by treatment at 900° C. FIG. 15 illustrates TGA curves for Super P (Timcal) carbon (a) compared to silicon/carbon nanocomposite nanofibers prepared by treatment at 900° C. (b) and 1200° C. (c). FIG. 16 illustrates Raman spectra for Super P (Timcal) carbon (a) compared to silicon/carbon nanocomposite nanofibers prepared by treatment at 900° C. (b) and 1200° C. (c).

XRD done using Scintag 2-theta diffractometer; SEM with Leica 440 SEM; TEM with FEI Spirit TEM.

### Example 4

### Silicon Nanocomposite Nanofibers—Polymer Loading

Fluid stock: 0.5 g PVA (88% hydrolyzed, 78 kDa) was combined with 4.5 g water and heated at 95 C for at least 8 hours. Silicon nanoparticles (purchased from Silicon and Amorphous Materials, Inc., 20-30 nm (actual average size about 50 nm)) added to the polymer solution and sonicated at room temperature for 4 hours. Heated and mixed at 50 C for 4 hours. Silicon nanoparticles are added in ratios of polymer:Si of 20:1, 4:1, 2:1, and 1:1.

Nanofibers: the fluid stock is gas-assisted electrospun from a needle apparatus having an inner needle and an outer needle coaxially aligned, the inner needle providing the fluid stock, the outer needle providing the gas. The fluid stock is provided at a flow rate of 0.01 mL/min; the voltage used is 20 kV, the needle apparatus tip to collector distance is 15 cm.

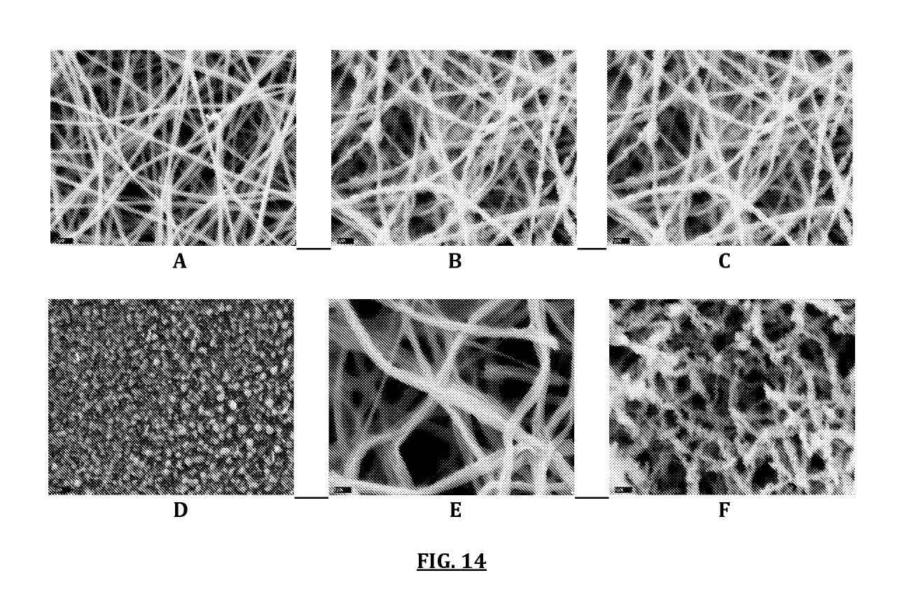

The electrospun nanofiber is a polymer-Si (nanoparticle) nanocomposite nanofiber illustrated in FIG. 14 (panel A for 20:1; panel B for 2:1; panel C for 1:1). The nanofibers are then treated with heat under Argon: at 900° C. (heat and cool rate of 2° C./minute). FIG. 14 also illustrates an SEM image of a silicon/carbon nanocomposite nanofibers prepared by such thermal treatment (panels D for 20:1, panel E for 2:1, panel F for 1:1). Table 1 demonstrates components of the produced nanocomposite nanofibers (as determined by TGA; calculation based on assumption of no Si nanoparticle loss):

TABLE 1

| | |
|---|---|
| Polymer/Si | |
| NC NF | Si/C NC NF |

| | PVA | Si | Carbon | Si |
|---|---|---|---|---|
| PVA/Si (1:1) | 50% | 50% | 1.3% | 98.7% |
| PVA/Si (2:1) | 67% | 33% | 14.9% | 85.1% |
| PVA/Si (4:1) | 80% | 20% | 19.3% | 80.7% |
| PVA/Si (20:1) | 95% | 5% | 50.1%* | 49.9%* |

*Nanofiber morphology not observed.

### Example 5

### Si/C Nanocomposite Nanofibers as Negative Electrode in Lithium Ion Battery

Coin cell-typed Li-ion batteries were fabricated by using various Si—C nanofibers. The C—SiNPs nanofibers were blended with Super P (Timcal) and poly(acrylic acid) (PAA, Mw=3,000,000) for 70:15:15 wt % in 1-Methyl-2-pyrrolidinone (NMP, Aldrich) in order to make a homogeneous slurry without breaking the 1-D nanostructures. After the slurries were dropped on a current collector with 9 thickness (Cu foil, MTI), the working electrodes using C—SiNPs nanofibers were dried in the vacuum oven at 80° C. to remove the NMP solvent.

For fabricating the half cells, Li metal was used as a counter electrode and polyethylene (ca. 25 thickness) was inserted as a separator between working electrode and counter electrode. The mass of working electrode was 3˜4 mg/cm². The coin cell-typed Li-ion batteries were assembled in Ar-filled glove box with electrolyte.

The cut off voltage during the galvanostatic tests was 0.01˜2.0 V for anode and 2.5˜4.2 V by using battery charge/discharge cyclers from MTI. Full cells are prepared in a similar manner, and are composed of C—Si nanofibers as anode and stock-LiCoO₂ as cathode. The cut off voltage during the galvanostatic tests was 2.5˜4.5 V. The impedance measurements for all battery cells were performed from 1 Hz to 10 kHz frequency under potentiostatic mode at open circuit voltages of the cells.

The electrochemical properties of Si—C nanofibers were characterized by cyclic voltammetry and electrochemical impedance spectroscopy. FIG. 10 (panel A) illustrates cyclic voltammograms of Si nanoparticles and Si—C nanofibers (prepared according to Example 4 using a polymer-to-Si nanoparticle ratio of 2:1). Delithiation is observed at 0.3 V (vs. Li/Li⁺) and lithiation is observed at 0.15 V (vs. Li/Li⁺). Charge transport resistance of C—Si nanofibers in the Nyquist plots of FIG. 10 (panel B) obtained from AC impedance, is greatly reduced to about 60Ω, compared with that of Si nanoparticles (about 220Ω). Furthermore, the solution (polarization) resistance in C—Si nanofibers is decrease by 4.1Ω from 7.4Ω of pure silicon nanoparticles.

The cells were cycled for 25 cycles as shown in FIG. 7 and FIG. 8. FIG. 7 (panel A) illustrates that Nancomposite Si—C nanofibers show an initial discharge capacity of 1,844 mAh/g, while SiNPs has an initial discharge capacity of 3,325 mAh/g. The discharge capacity of SiNPs is dramatically decreased to 50 mAh/g after 25 cycles. Si—C nanocomposite nanofibers have a discharge capacity of 1,452 mAh/g after 25 cycles. FIG. 7 (panel B) illustrate that the coulombic efficiencies of Si—C nanocomposite nanofibers are maintained over 90% during 25 cycles. FIG. 8 illustrates that Si—C nanocomposite nanofibers have outstanding cyclabilities from 0.1 to 1 C. Conversely, SiNPs have very low capacities (e.g., about 50 mAh/g at 0.5 C, 0.8 C, and 1 C). The discharge capacities of the prepared Si—C nanocomposite nanofibers are 1,150 mAh/g at 0.5 C and 1,000 mAh/g at 0.8 C.

Table 2 illustrates cycling performance (at 0.1 C) of various Si/C nanocomposite nanofibers prepared according to the Examples.

TABLE 2

| | Carbon | Specific capacity (mAh/g) | | | | |
|---|---|---|---|---|---|---|
| | content | 1st | 10^{th} | | | |
| | (from TGA) | Cycle | Cycle | 20^{th} | 50^{th} | 98^{th} |
| Si NP | 0% | 3,310 | 509 | 131 | 22 | 13 |
| PVA/Si (1:1) | 3% | 2,548 | 1,446 | 1,161 | 908 | 463 |
| PVA/Si (2:1) | 8% | 2,091 | 1,851 | 1,607 | 1,011 | 286 |
| PVA/Si (4:1) | 14% | 1,845 | 1,688 | 1,540 | 1,074 | 411 |

### Example 6

### Si/C Nanocomposite Nanofibers without Gas Assistance

Using a procedure similar to that set forth in Examples 1 and 2, nanocomposite nanofibers comprising silicon nanofibers were prepared without gas assistance. FIG. 5 (panels A and B) illustrate TEM images of the resultant Si/polymer nanocomposite nanofibers.

### Example 7

### Si/C Nanocomposite Nanofibers from PAN/DMF Stock

Fluid stock: is prepared similar to as set forth in Example 1 and Example 3, using polyacrylonitrile (PAN) as the polymer and dimethylformamide (DMF) as the solvent. Polyacrylonitrile (PAN) is combined with DMF. Silicon nanoparticles are added to the polymer solution, mixed and heated.

Nanofibers: the fluid stock is gas-assisted electrospun from a needle apparatus having an inner needle and an outer needle coaxially aligned, the inner needle providing the fluid stock, the outer needle providing the gas. The fluid stock is provided at a flow rate of 0.01 mL/min; the voltage used is 20 kV, the needle apparatus tip to collector distance is 15 cm.

### Example 8

### Si/C Nanocomposite Nanofibers without Gas Assistance

Using a procedure similar to that set forth in Example 7, nanocomposite nanofibers comprising silicon nanofibers were prepared without gas assistance. FIG. 5 (panels C and D) illustrate TEM images of the resultant Si/polymer nanocomposite nanofibers.

Using a procedure similar to that set forth in Examples 1, 3, and 7, PAN/Si and PVA/Si polymer/Si nanocomposite nanofibers are prepared without gas assistance. The Si nanoparticles utilized in the fluid stock have an average diameter of about 100 nm. Thermal treating to carbonize the polymer is performed at 500 C. Table 3 illustrates the charge capacities of the resultant nanofibers (as lithium ion half cell anodes) at 400 mA/g.

TABLE 3

| | From | From |
|---|---|---|
| | PAN/Si | PVA/Si |
| Cycle | (mAh/g) | (mAh/g) |
| 1 | 382.1 | 49.2 |
| 2 | 117.9 | 40.8 |
| 3 | 89.3 | 38.3 |
| 4 | 78.6 | 36.7 |
| 5 | 75.0 | 35.8 |
| 6 | 71.4 | 34.2 |
| 7 | 71.4 | 33.3 |
| 8 | 67.9 | 33.3 |
| 9 | 67.9 | 32.5 |
| 10 | 67.9 | 31.7 |
| 11 | 64.3 | 31.7 |
| 12 | 64.3 | 30.8 |
| 13 | 64.3 | 30.0 |
| 14 | 64.3 | 30.0 |
| 15 | 64.3 | 29.2 |
| 16 | 64.3 | 29.2 |
| 17 | 60.7 | 28.3 |
| 18 | 60.7 | 28.3 |
| 19 | 60.7 | 28.3 |
| 20 | 60.7 | 27.5 |

### Example 9

### Hollow Si/C Nanocomposite Nanofibers

Fluid stock: is prepared similar to as set forth in Example 1, Example 3, and Example 7 using polyacrylonitrile (PAN) as the polymer and dimethylformamide (DMF) as the solvent. Polyacrylonitrile (PAN) is combined with DMF. Silicon nanoparticles are added to the polymer solution, mixed and heated.

Nanofibers: the fluid stock is gas-assisted electrospun from a needle apparatus having an inner needle and an outer needle coaxially aligned, the inner needle providing air, the outer needle providing the fluid stock. Additional gas assistance surrounding the fluid needle is optionally utilized. The gas and fluid stock is provided at a flow rate of 0.008 mL/min to 0.017 mL/min; the voltage used is 10-15 kV, the needle apparatus tip to collector distance is 10-15 cm.

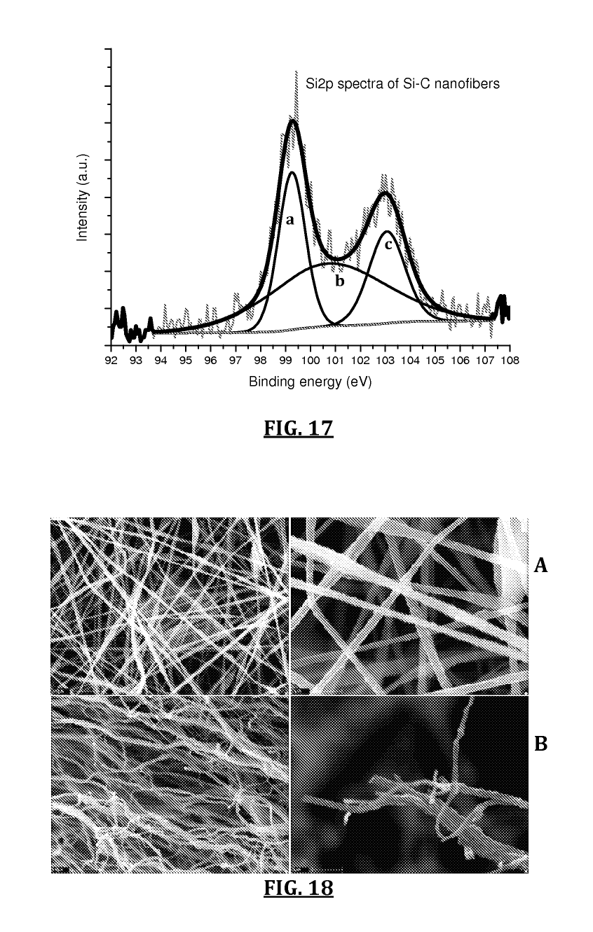

FIG. 18 illustrates as spun nanofibers using a polymer:Si nanoparticle ratio of 5:1, and Si nanoparticles having an average diameter of about 100 nm. The as-spun nanofibers are calcined under argon, producing carbon-silicon nanocomposite nanofibers having a carbon:silicon ratio of 1.9:1. Panel A illustrates SEM images of as-spun nanofibers; panel B illustrates SEM images of calcined nanofibers.

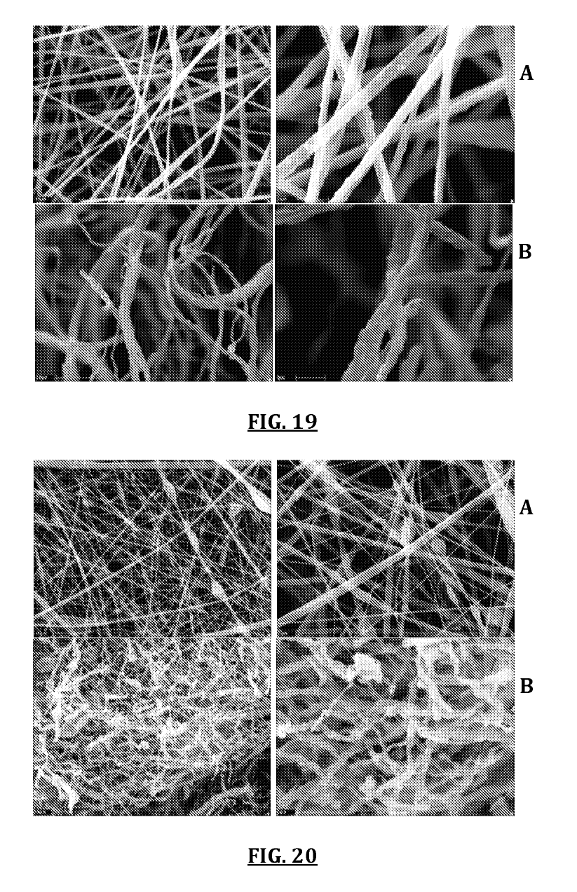

FIG. 19 illustrates as spun nanofibers using a polymer:Si nanoparticle ratio of 3.2:1, and Si nanoparticles having an average diameter of about 100 nm. The as-spun nanofibers are calcined under argon, producing carbon-silicon nanocomposite nanofibers having a carbon:silicon ratio of 1.2:1. Panel A illustrates SEM images of as-spun nanofibers; panel B illustrates SEM images of calcined nanofibers.

FIG. 20 illustrates as spun nanofibers using a polymer:Si nanoparticle ratio of 1.84:1, and Si nanoparticles having an average diameter of about 100 nm. The as-spun nanofibers are calcined under argon, producing carbon-silicon nanocomposite nanofibers having a carbon:silicon ratio of 0.7:1. Panel A illustrates SEM images of as-spun nanofibers; panel B illustrates SEM images of calcined nanofibers.

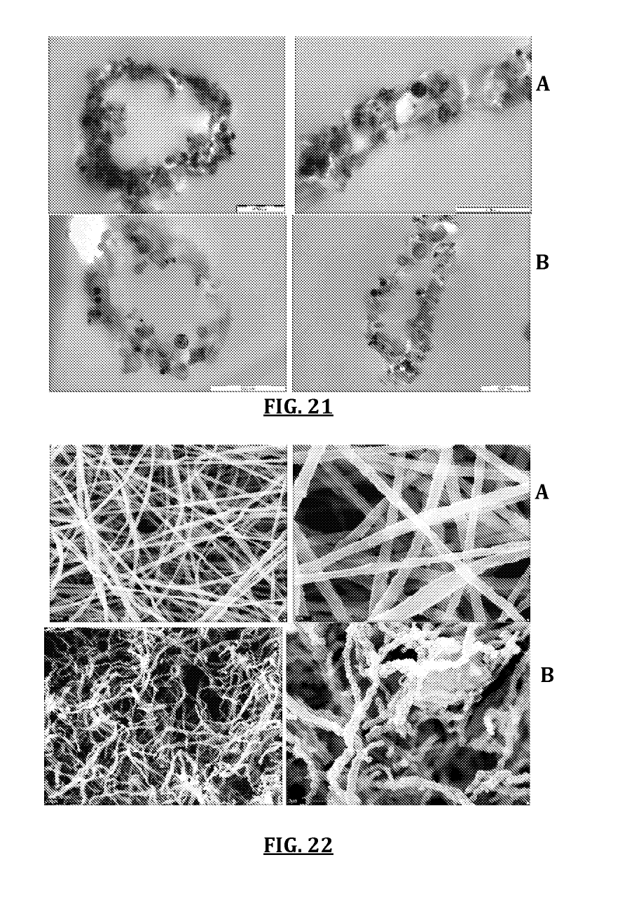

FIG. 21 illustrates a TEM image of microtomed hollow Si/C nanocomposite nanofibers described herein (from Si nanoparticles having an average diameter of 100 nm).

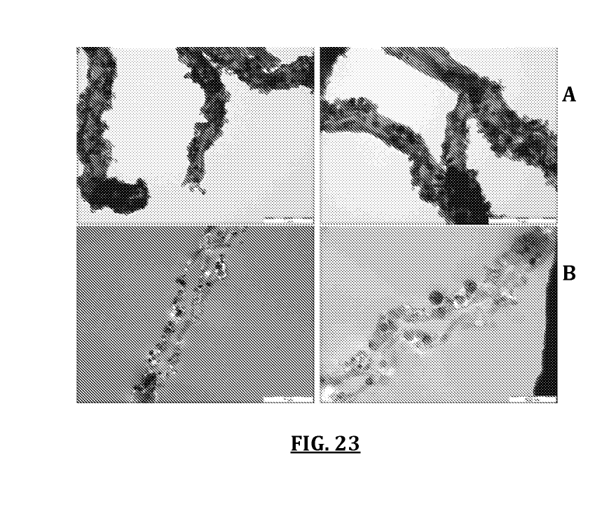

FIG. 22 illustrates as spun nanofibers using Si nanoparticles having an average diameter of about 50 nm. The as-spun nanofibers are calcined under argon, producing carbon-silicon nanocomposite nanofibers having a carbon:silicon ratio of 1:1. Panel A illustrates SEM images of as-spun nanofibers; panel B illustrates SEM images of calcined nanofibers.

FIG. 23 illustrates TEM images of microtomed hollow Si/C nanocomposite nanofibers described herein (from Si nanoparticles having an average diameter of 50 nm).

Hollow nanofibers prepared using Si nanoparticles with an average diameter of 50 nm are described in Table 4 (32 wt % Si in carbon matrix):

TABLE 4

| | |
|---|---|
| All Materials | Silicon |

| | Discharge | Charge | Discharge | Charge |
|---|---|---|---|---|
| Cycles | (mAh/g) | (mAh/g) | (mAh/g) | (mAh/g) |
| 1 | 1381.4 | 1062.3 | 4256.4 | 3273.3 |
| 2 | 1086.8 | 1045.0 | 3348.7 | 3220.1 |
| 3 | 1104.8 | 1070.8 | 3404.1 | 3299.4 |
| 4 | 1092.0 | 1063.4 | 3364.9 | 3276.7 |
| 5 | 1081.6 | 1059.6 | 3332.6 | 3265.0 |
| 6 | 1082.2 | 1060.3 | 3334.5 | 3267.1 |
| 7 | 1097.8 | 1075.6 | 3382.5 | 3314.4 |
| 8 | 1079.1 | 1056.7 | 3324.9 | 3256.1 |
| 9 | 1175.3 | 1146.1 | 3621.5 | 3531.6 |
| 10 | 1360.0 | 1318.3 | 4190.7 | 4062.1 |
| 11 | 1349.7 | 1315.4 | 4148.7 | 4053.0 |
| 12 | 1316.5 | 1291.8 | 4056.6 | 3980.5 |
| 13 | 1317.9 | 1289.9 | 4060.8 | 3974.7 |
| 14 | 1303.9 | 1271.7 | 4017.6 | 3918.6 |
| 15 | 1295.6 | 1261.1 | 3992.2 | 3885.8 |
| 16 | 1276.9 | 1246.5 | 3934.6 | 3841.0 |

Hollow nanofibers prepared using Si nanoparticles with an average diameter of 100 nm are described in Table 5 (50 wt % Si in carbon matrix):

TABLE 5

| | All materials | | Silicon | |
|---|---|---|---|---|
| Cycles | DChg (mAh/g) | Chg (mAh/g) | DChg (mA/gh) | Chg (mAh/g) |
| 1 | 1171.5 | 878.1 | 2332.7 | 1748.6 |
| 2 | 977.4 | 928.6 | 1946.1 | 1849.0 |
| 3 | 982.9 | 944.3 | 1957.2 | 1880.3 |
| 4 | 989.4 | 958.9 | 1970.1 | 1909.4 |
| 5 | 992.1 | 963.0 | 1975.4 | 1917.6 |
| 6 | 997.0 | 968.9 | 1985.3 | 1929.2 |
| 7 | 993.0 | 973.6 | 1977.4 | 1938.7 |
| 8 | 996.2 | 977.0 | 1983.6 | 1945.4 |
| 9 | 996.4 | 971.1 | 1984.1 | 1933.8 |
| 10 | 994.1 | 973.5 | 1979.5 | 1938.5 |
| 11 | 988.2 | 967.4 | 1967.7 | 1926.4 |
| 12 | 984.1 | 964.0 | 1959.6 | 1919.5 |
| 13 | 975.2 | 954.9 | 1941.9 | 1901.4 |
| 14 | 969.1 | 947.9 | 1929.6 | 1887.5 |
| 15 | 967.6 | 946.0 | 1926.7 | 1883.7 |
| 16 | 958.9 | 934.7 | 1909.4 | 1861.2 |
| 17 | 958.2 | 932.0 | 1908.0 | 1855.9 |
| 18 | 954.3 | 926.7 | 1900.2 | 1845.3 |
| 19 | 947.4 | 920.7 | 1886.6 | 1833.3 |
| 20 | 945.1 | 924.8 | 1881.9 | 1841.4 |
| 21 | 931.7 | 906.7 | 1855.2 | 1805.4 |
| 22 | 926.9 | 902.0 | 1845.6 | 1796.1 |
| 23 | 922.6 | 897.3 | 1837.1 | 1786.7 |
| 24 | 911.4 | 882.4 | 1814.7 | 1757.1 |
| 25 | 901.0 | 875.3 | 1794.0 | 1742.9 |
| 26 | 891.6 | 865.1 | 1775.4 | 1722.5 |
| 27 | 879.7 | 850.9 | 1751.7 | 1694.3 |
| 28 | 870.2 | 842.2 | 1732.7 | 1677.1 |
| 29 | 856.4 | 829.9 | 1705.4 | 1652.5 |
| 30 | 849.1 | 821.7 | 1690.8 | 1636.2 |
| 31 | 837.1 | 805.8 | 1666.9 | 1604.6 |
| 32 | 827.8 | 798.8 | 1648.2 | 1590.6 |

We claim:

1-57. (canceled)

58. A composition comprising a plurality of nanocomposite nanofibers comprising a carbon backbone, the carbon backbone comprising nanoparticles embedded therein, the nanoparticles comprising silicon, and the composition comprising on average at least 50 elemental wt % silicon.

59. The composition of claim 58, wherein the composition comprises on average less than 30 wt % carbon.

60. The composition of claim 58, wherein the nanoparticles further comprise silicon dioxide.

61. The composition of claim 58, wherein the silicon comprises crystalline silicon.

62. The composition of claim 58, wherein the nanoparticles have an average diameter of less than 100 nm and an aspect ratio of at least 100.

63. The composition of claim 58, wherein the nanofibers comprise on average at least 75 elemental wt. % of silicon.

64. The composition of claim 58, wherein the nanoparticles are non-aggregated.

65. The composition of claim 58, comprising XRD two theta peaks at three or more of the following: 28.37°±0.03, 47.20°±0.03, 56.09°±0.03, 69.02°±0.03, and 76.37°±0.03.

66. A lithium ion battery comprising an anode, a cathode, and a separator, the anode comprising a composition of claim 58.

67. The lithium ion battery of claim 66, wherein the anode has a specific energy capacity of at least 1500 mAh/g on a first cycle at 0.1 C.

68. The lithium ion battery of claim 66, wherein the anode has a specific energy capacity of at least 400 mAh/g on a 98^{th} cycle at 0.1 C.

69. A process of producing a nanocomposite nanofiber, the process comprising gas-assisted electrospinning a fluid stock, the fluid stock comprising a combination of silicon nanoparticles, an organic polymer, and a fluid.

70. The process of claim 69, wherein the fluid is aqueous.

71. The process of claim 69, wherein the organic polymer is polyvinylalcohol (PVA), polyacrylonitrile (PAN), or polyvinylpyrrolidone (PVP).

72. The process of claim 69, wherein the weight-to-weight ratio of the silicon nanoparticles to organic polymer is at least 1:4.

73. The process of claim 72, wherein the weight-to-weight ratio of the silicon nanoparticles to organic polymer is at least 1:2.

74. The process of claim 69, further comprising thermally carbonizing the nanofiber.

75. The process of claim 73, wherein the nanofiber is thermally carbonized at a temperature of about 500 C to about 2000 C.

76. The process of claim 73, wherein the nanofiber is thermally carbonized under inert conditions.

77. The process of claim 69, wherein the nanofiber comprises at least 50 elemental wt % silicon.

78. The process of claim 69, wherein the nanofiber comprises at least 50 elemental wt % silicon and less than 30 wt % carbon.
